(19) United States
(12) Patent Application Publication
(10) Pub. No.: US 2007/0110249 A1
(43) Pub. Date: May 17, 2007

(54) Method of acoustic signal reproduction

(76) Inventors: Masaru Kimura, Tokyo (JP); Bunkei Matsuoka, Tokyo (JP)

Correspondence Address: BIRCH STEWART KOLASCH & BIRCH, PO BOX 747, FALLS CHURCH, VA, 22040-0747, US

(21) Appl. No.: 10/582,863

(22) PCT Filed: Dec. 7, 2004
(86) PCT No.: PCT/JP04/18192

§ 371 Date: Jun. 14, 2006

(30) Foreign Application Priority Data
Dec. 24, 2003 (JP) 203-426502

(51) Int. Cl. H04R 5/00

(52) U.S. Cl. 381/17; 381/18

(57) ABSTRACT

Up to now, there have existed filters having a transfer function for canceling crosstalk components arriving from loudspeakers, at the listener's right/left ear, however, such filters have been incapable of properly reducing the inter-loudspeaker crosstalk components inside the casing of a mobile terminal. Therefore, when input signals are expected to produce stereophonic effects, three-dimensional sound image localization has not been realized in mobile terminals. In a method of acoustic signal reproduction in a mobile terminal with at least two loudspeakers accommodated inside the casing of the terminal, a crosstalk canceling method relating to the present invention comprises Processing Step 1 for reducing spatial crosstalk that is generated with respect to the input signals to the loudspeakers, in a space ranging from the loudspeaker to the listener's ears, and Processing Step 2 for reducing crosstalk that is generated between the loudspeakers inside the casing, with respect to Processing-Step-1-processed signals.

### TECHNICAL FIELD

The present invention relates to methods of acoustic signal reproduction, for reducing crosstalk that is generated at the time of using a mobile terminal.

### BACKGROUND ART

Conventional crosstalk cancellers are characterized by a filter having a transfer function for canceling crosstalk components arriving at the listener's right/left ear, in regard to the transfer function through which virtual acoustic image corresponding to input signals is considered to arrive at the listener's right/left ear.

Patent Document 1

Japanese Laid-Open Patent Publication H09-327099 (pages 1 and 2)

Patent Document 2

Japanese Laid-Open Patent Publication 2002-111817 (pages 1, 2, 9 and 10)

### DISCLOSURE OF THE INVENTION

Up to now, there have existed filters having a transfer function for canceling crosstalk components arriving from loudspeakers, at the listener's right/left ear, however, such filters have been incapable of properly reducing inter-loudspeaker crosstalk components inside the casing of a mobile terminal. Therefore, when input signals are expected to produce stereophonic effects, mobile terminals have not realized three-dimensional sound image localization. [0005] In a method of acoustic signal reproduction in a mobile terminal with at least two loudspeakers accommodated inside the casing thereof, a crosstalk canceling method of the present invention comprises Processing Step 1 of reducing spatial crosstalk that is generated, with respect to input signals to the loudspeakers, in a space ranging from the loudspeakers to the listener's ears, and Processing Step 2 of reducing crosstalk that is generated between the loudspeakers inside the casing, with respect to Processing-Step-1-processed signals.

In a method of acoustic signal reproduction in a mobile terminal with at least two loudspeakers accommodated inside a casing the mobile terminal, a crosstalk canceling method of the invention comprises Processing Step 1 of reducing spatial crosstalk that is generated, with respect to the input signals of the loudspeakers, in a space ranging from loudspeakers to the listener's ears, and Processing Step 2 of reducing crosstalk that is generated between the loudspeakers inside the casing, with respect to Processing-Step-1 processed signals, allowing the mobile terminal to realize three-dimensional (3D) sound image localization when the input signals are anticipated to produce the stereophonic effects.

### BRIEF DESCRIPTION OF DRAWINGS

FIG. 1 is a diagram illustrating a reproduction model of spatial reproduction system inside a casing in Embodiments 1 through 6;

FIG. 2 is a conceptual diagram of crosstalk cancellation in Embodiment 1;

FIG. 3 is a conceptual diagram of crosstalk cancellation in Embodiment 2;

FIG. 4 is a conceptual diagram of crosstalk cancellation in Embodiment 3;

FIG. 5 is a conceptual diagram of crosstalk cancellation in Embodiment 4;

FIG. 6 is a conceptual diagram of crosstalk cancellation in Embodiment 6;

FIG. 7 is a diagram illustrating a reproduction model of spatial reproduction system inside a casing in Embodiment 7;

FIG. 8 is a conceptual diagram of crosstalk cancellation in Embodiment 7; and

FIG. 9 is a conceptual diagram of crosstalk cancellation in Embodiment 7.

### BEST MODE FOR CARRYING OUT THE INVENTION

### Embodiment 1

The inventor's study has revealed that when a speaker-rear air chamber is used in common in order to downsize a casing of a mobile terminal, there occurs a phenomenon in that sound waves being emanated from one loudspeaker acoustically couple with each other inside the casing, and leak out into the other loudspeaker.

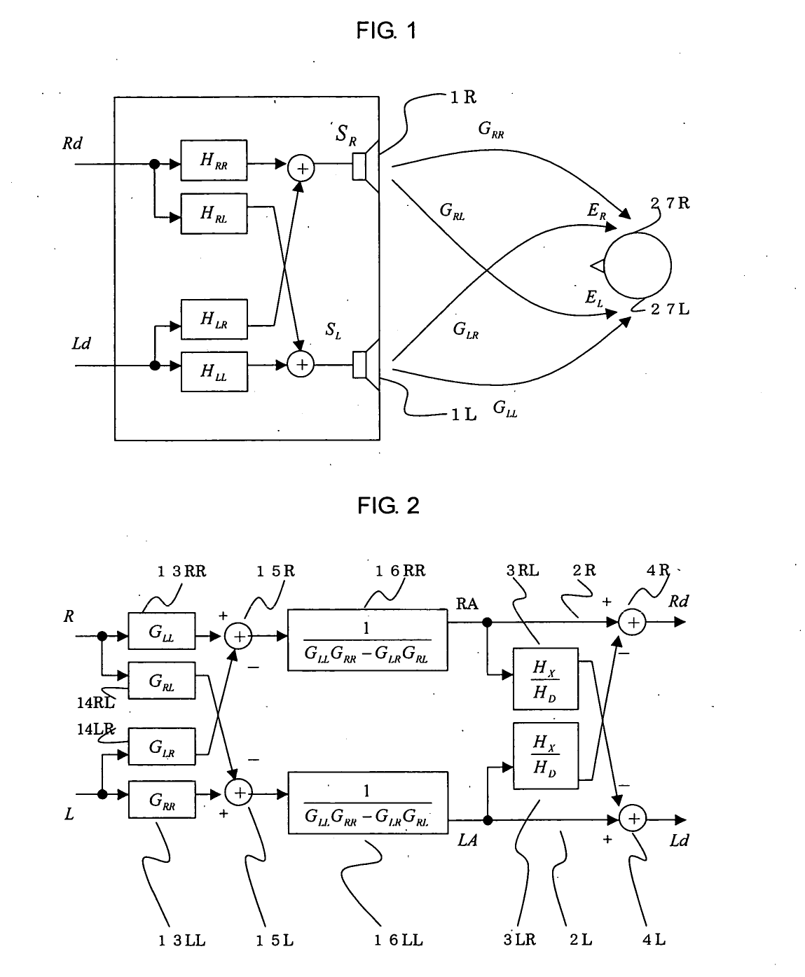

This acoustic coupling is referred to as in-casing crosstalk. The left part of FIG. 1 is a modeling of this phenomenon. It has also turned out that there has occurred a phenomenon in that sound waves emanated from one loudspeaker, while supposed to arrive at either ear of a listener, couple with each other at the other ear and leak thereinto. This acoustic coupling is referred to as spatial crosstalk. The right part of FIG. 1 is a modeling of this phenomenon.

A first loudspeaker 1R (one loudspeaker) and a second loudspeaker 1L (the other loudspeaker) each illustrated in FIG. 1 are housed inside a mobile terminal, not shown, and the speaker-rear air chamber is shared. Furthermore, as shown in the Figure, a transfer function for a driving signal LD, as altered by at least acoustic couplings inside the casing until emitted from the first loudspeaker, is represented by HLR, and a transfer function for a driving signal RD, as altered by at least acoustic couplings inside the casing until emitted from the first loudspeaker, is represented by HRL. Moreover, a transfer function for the driving signal RD, for driving the first loudspeaker 1R, as altered by amplifier and loudspeaker characteristics and the like until emitted from the loudspeaker 1R, is represented by H_{RR}, a n d a transfer function for a driving signal LD, for driving the second loudspeaker 1L, as altered by amplifier and loudspeaker characteristics, and the like until emitted from the second loudspeaker 1L, is represented by H_{LL}. Furthermore, a loudspeaker's emission signal being emitted from the first loudspeaker 1R through the transformation, is represented by SR, and the loudspeaker's emission signal being emitted from the second loudspeaker 1L is represented by SL. Then, a transfer function for a loudspeaker's emission signal SR, as altered in space until arriving at the listener's first ear that is an example of a first control point 27R, is represented by G_{RR}, and a transfer function for a loudspeaker's emission signal SL, as altered in space until arriving at the listener's first ear that is an example of a first control point 27L, is represented by G_{LL}. A transfer function for the loudspeaker's emission signal SL, as altered in space until arriving at the listener's first ear, is represented by G_{LR}, and a transfer function for the loudspeaker's emission signal SR, as altered in space until arriving at the listener's second ear, is represented by G_{RL}.

As illustrated in FIG. 1, in a mobile terminal having acoustic couplings inside the casing, the driving signal RD is processed by a filtering means having the transfer function of H_{RR}, furthermore, the driving signal LD being processed by a filtering means having the transfer function of H_{LR}, then, both signals are summed together and emitted. On the other hand, the driving signal LD is processed by a filtering means having the transfer function of H_{LL}, and also the driving signal RD is processed by a filtering means having the transfer function of H_{RL}, and then both signals are summed together and emitted. Therefore, the first loudspeaker's emission signal SR and the second loudspeaker's emission signal SL can be expressed as Equation 1.
S_{R}=RdH_{RR}+LdH_{LR}
S_{L}=LdH_{LL}+RdH_{RL} Equation 1

It should be noted that in Embodiment 1 of the invention, the first loudspeaker 1R and the second loudspeaker 1L are assumed to be symmetrically arranged inside the casing of the mobile terminal, with respect to the casing center, and both loudspeakers to have similar characteristics. Accordingly, when the transfer functions H_{RL} and H_{LR}, and the transfer functions H_{RR} and H_{LL} are common to each other, or those are considered to be so approximate to each other as assumed to be common to each other, it is assumed that H_{LR}=H_{RL}=H_{X}, H_{RR}=H_{LL}=H_{D}. Accordingly, in Embodiment 1 of the invention, the first loudspeaker's emission signal SR and the second loudspeaker's emission signal are expressed as Equation 2.
S_{R}=RdH_{D}+LdH_{X}
S_{L}=LdH_{D}+RdH_{X} Equation 2

Furthermore, the reproduced first loudspeaker's emission signal SR is processed by a filtering means having a transfer function of G_{RR}, and the second loudspeaker's emission signal SR is processed by a filtering means having a transfer function of G_{LR}. Then, both signals are summed together and transmitted to the listener's first ear. On the other hand, the second loudspeaker's emission signal SL is processed by a filtering means having a transfer function of G_{LL}, while the second loudspeaker's emission signal SR being processed by a filtering means having a transfer function of G_{LR}. Then, both signals are summed together and transmitted to the listener's second ear. A signal ER transmitted to the listener's first ear and a signal EL transmitted to the listener's second ear are expressed as Equation 3.

$$\begin{matrix}{E}_{R} = {S}_{R} {G}_{RR} + {S}_{L} {G}_{LR} \\ = ( {RdH}_{D} + {LdH}_{X} ) {G}_{RR} + ( {LdH}_{D} + {RdH}_{X} ) {G}_{LR} \\ = Rd ( {H}_{D} {G}_{RR} + {H}_{X} {G}_{LR} ) + Ld ( {H}_{D} {G}_{LR} + {H}_{X} {G}_{RR} )\end{matrix} \\ \begin{matrix}{E}_{L} = {S}_{L} {G}_{LL} + {S}_{R} {G}_{RL} \\ = ( {LdH}_{D} + {RdH}_{X} ) {G}_{LL} + ( {RdH}_{D} + {LdH}_{X} ) {G}_{RL} \\ = Rd ( {H}_{D} {G}_{RL} + {H}_{X} {G}_{LL} ) + Ld ( {H}_{D} {G}_{LL} + {H}_{X} {G}_{RL} )\end{matrix} \qquad Equation 3$$

In order to create stereophonic effects, it is made necessary to generate signals being expected to bring about the stereophonic effects, and present the signals as accurately to the left/right ear as possible. As shown in Equation 3, however, the transmission signal ER to the first ear includes both components of the driving signal RD and the driving signal LD, while the transmission signal EL to the second ear including both components of the driving signal RD and the driving signal LD. Consequently, when, with no pre-processing performed, there exists acoustic couplings inside the casing or in space, acoustic image reproduced on the loudspeaker, in some cases, may become extremely narrow, and sound reproduction with the sense of being present may not be achieved. The inventor has taken note of the above-described phenomenon, and aimed at reductions of the in-casing crosstalk and spatial crosstalk, by implementing an acoustic signal reproduction circuit as shown in FIG. 2, at the front stage of the reproduction model as shown in FIG. 1.

FIG. 2 is a general diagram of an acoustic signal reproduction circuit for use in a mobile terminal relating to Embodiment 1 of the invention. As illustrated in FIG. 2, the acoustic signal reproduction circuit relating to Embodiment 1 of the invention is provided with a channel 2R for the above-described first loudspeaker 1R, and a channel 2L for the above-described first loudspeaker 1L. Moreover, this acoustic signal reproduction circuit also includes a first spatial direct processing means 13RR for producing, by processing an input signal R to the first loudspeaker, a direct component to the first loudspeaker 1R; a first spatial crossover processing means 14LR for producing, by processing an input signal L to the second loudspeaker, a crossover component to the first loudspeaker 1R; and a summing means 15R for producing summing signals, by summing together the above-described both signals. Similarly, the circuit further includes a second spatial direct processing means 13LL for producing, by processing an input signal L to the second loudspeaker 1L, a direct component to the second loudspeaker 1L; a second spatial crossover processing means 14RL for producing, by processing an input signal R to the second loudspeaker 1L, crossover components to the second loudspeaker 1L; and a summing means 15L for producing a summing signal, by summing together the above-described both signals.

Furthermore, the circuit includes a first spatial post-processing means 16RR for further processing signals summed by a first summing means 15R, and a second spatial post-processing means 16LL for further processing signals summed by a second summing means 15L.

In addition to the above-described spatial crosstalk processing means (processing means 1), an in-casing crosstalk processing means (processing means 2) described below is provided. The circuit comprises a first in-casing processing means 3LR for producing the crossover component to the first speaker 1R, by further processing signals (processing-means-1-processed signals to the other loudspeaker) that have been processed by the second spatial post-processing means 16LL; and a summing means 4R for outputting the driving signal RD, by summing together output signals from the first in-casing processing means 3LR and output signals (processing-means-1-processed signals to one loudspeaker) from the first spatial post-processing means 16RR. In a similar way, the circuit comprises a second in-casing processing means 3LR for producing crossover components to the second speaker 1R, by further processing signals processed by means of the first spatial post-processing means 16RR; and a summing means 4L for outputting the driving signal LD, by summing together output signals from the second in-casing processing means 3RL and output signals from the second spatial post-processing means 16LL.

In Embodiment 1 of the invention, the driving signals RD and LD are used as the driving signals RD and LD as illustrated in above-described FIG. 1, respectively.

Next, the operation will be described. The input signal R inputted into the first channel of a mobile terminal of the present invention is divided into two portions: one being inputted into the second spatial crossover processing means 14RL, and the other being inputted into the first spatial crossover processing means 13RR. In a similar way, the input signal L inputted into the second channel of the mobile terminal of the present invention is divided into two portions: one being inputted into the second spatial crossover processing means 14LR, and the other being inputted into the first spatial crossover processing means 13LL. Next, the input signal inputted into the second spatial crossover processing means 14LR, is inputted passing through a filter having a transfer function of, e.g., −G_{RL}, into the second summing means 15L. The input signal inputted into the first spatial direct processing means 13RR is inputted passing through a filter having a transfer function of, e.g., −G_{LL}, into the first summing means 15R. Similarly, the input signal inputted into the first spatial crossover processing means 14LR is inputted passing through a filter having a transfer function of, e.g., −G_{LR}, into the first summing means 15R. The input signal inputted into the second spatial direct processing means 13RR is inputted passing through a filter having a transfer function of, e.g., −G_{RR} into the second summing means 15L.

Next, both signals inputted into the first summing means 15R are summed together and inputted into the first spatial post-processing means 16RR, and both signals inputted into the second summing means 15L are summed together and inputted into the second spatial post-processing means 16LL. Then, the signals inputted into the first spatial post-processing means 16RR, are divided through a filter having a transfer function of, e.g., 1/(G_{LL}G_{RR}−G_{LR}G_{RL}) into two portions: one, as a crossover component, being inputted into the second in-casing processing means 3RL, and the other, as a direct component, being inputted into the first summing means 4R. Similarly, the signals inputted into the second spatial post-processing means 16LL, are divided through a filter having a transfer function of, e.g., 1/(G_{LL}G_{RR}−G_{LR}G_{RL}) into two portions: one, as a crossover component, being inputted into the first in-casing processing means 3LR, and the other, as a direct component, being inputted into the second summing means 4 L. Assuming that a signal inputted into the first in-casing processing means 3LR be a signal LA, the signal LA is inputted, passing through a filter having a transfer function of, e.g., −H_{X}/H_{D}, by means of the first in-casing processing means 3LR, into the first processing means 4R. In the first summing means 4R, the driving signal RD is produced by summing together an output signal (crossover components) from the first in-casing processing means 3LR, and a signal RA (direct components) outputted from the first in-casing processing means 16RR. Similarly, a signal RA inputted into the second in-casing processing means 3RL, is inputted, passing through a filter having a transfer function of, e.g., −H_{X}/H_{D}, by means of the second in-casing processing means 3RL, into the second summing means 4L. In the second summing means 4L, the driving signal LD is produced by summing together an output signal (crossover components) from the second in-casing processing means 3RL and the signal LA (direct components), where the driving signals RD and LD are given as Equation 4.

$$Rd = \frac{{RG}_{LL} - {LG}_{LR}}{{G}_{LL} {G}_{RR} - {G}_{LR} {G}_{RL}} - \frac{{LG}_{RR} - {RG}_{RL}}{{G}_{LL} {G}_{RR} - {G}_{LR} {G}_{RL}} \cdot \frac{{H}_{X}}{{H}_{D}} \\ Ld = \frac{{LG}_{RR} - {RG}_{RL}}{{G}_{LL} {G}_{RR} - {G}_{LR} {G}_{RL}} - \frac{{RG}_{LL} - {LG}_{LR}}{{G}_{LL} {G}_{RR} - {G}_{LR} {G}_{RL}} \cdot \frac{{H}_{X}}{{H}_{D}} \qquad Equation 4$$

When the first loudspeaker 1R and the loudspeaker 1L are driven by means of the driving signals RD and LD produced by the above-described processing, respectively, referring to FIG. 1, the loudspeaker's emission signal SR from the loudspeaker R, and the loudspeaker's emission signal SL (from the loudspeaker L) are given as Equation 5.

$$\begin{matrix}{S}_{R} = {RdH}_{D} + {LdH}_{X} \\ = ( \frac{{RG}_{LL} - {LG}_{LR}}{{G}_{LL} {G}_{RR} - {G}_{LR} {G}_{RL}} - \frac{{LG}_{RR} - {RG}_{RL}}{{G}_{LL} {G}_{RR} - {G}_{LR} {G}_{RL}} \cdot \frac{{H}_{X}}{{H}_{D}} ) {H}_{D} + \\ ( \frac{{LG}_{RR} - {RG}_{RL}}{{G}_{LL} {G}_{RR} - {G}_{LR} {G}_{RL}} - \frac{{RG}_{LL} - {LG}_{LR}}{{G}_{LL} {G}_{RR} - {G}_{LR} {G}_{RL}} \cdot \frac{{H}_{X}}{{H}_{D}} ) {H}_{X} \\ = ( {RG}_{LL} - {LG}_{LR} ) ( {H}_{D} - \frac{{H}_{X}^{2}}{{H}_{D}} ) ( \frac{1}{{G}_{LL} {G}_{RR} - {G}_{LR} {G}_{RL}} )\end{matrix} \\ \begin{matrix}{S}_{L} = {LdH}_{D} + {RdH}_{X} \\ = ( \frac{{LG}_{RR} - {RG}_{RL}}{{G}_{LL} {G}_{RR} - {G}_{LR} {G}_{RL}} - \frac{{RG}_{LL} - {LG}_{LR}}{{G}_{LL} {G}_{RR} - {G}_{LR} {G}_{RL}} \cdot \frac{{H}_{X}}{{H}_{D}} ) {H}_{D} + \\ ( \frac{{RG}_{LL} - {LG}_{LR}}{{G}_{LL} {G}_{RR} - {G}_{LR} {G}_{RL}} - \frac{{LG}_{RR} - {RG}_{RL}}{{G}_{LL} {G}_{RR} - {G}_{LR} {G}_{RL}} \cdot \frac{{H}_{X}}{{H}_{D}} ) {H}_{X} \\ = ( {LG}_{RR} - {RG}_{RL} ) ( {H}_{D} - \frac{{H}_{X}^{2}}{{H}_{D}} ) ( \frac{1}{{G}_{LL} {G}_{RR} - {G}_{LR} {G}_{RL}} )\end{matrix} \qquad Equation 5$$

Thus, the signal ER arriving at the first ear, and the signal EL arriving at the second ear are given as Equation 6.

$$\begin{matrix}{E}_{L} = {G}_{LL} {S}_{L} + {G}_{RL} {S}_{R} \\ = {G}_{LL} ( \frac{{LG}_{RR} - {RG}_{RL}}{{G}_{LL} {G}_{RR} - {G}_{LR} {G}_{RL}} ( {H}_{D} - \frac{{H}_{X}^{2}}{{H}_{D}} ) ) + \\ {G}_{RL} ( \frac{{RG}_{LL} - {LG}_{LR}}{{G}_{LL} {G}_{RR} - {G}_{LR} {G}_{RL}} ( {H}_{D} - \frac{{H}_{X}^{2}}{{H}_{D}} ) ) \\ = \frac{( {H}_{D} - \frac{{H}_{X}^{2}}{{H}_{D}} )}{{G}_{LL} {G}_{RR} - {G}_{LR} {G}_{RL}} \\ ( ( {LG}_{RR} {G}_{LL} - {RG}_{RL} {G}_{LL} + {RG}_{RL} {G}_{LL} + {LG}_{RL} {G}_{LR} ) \\ = L ( {H}_{D} - \frac{{H}_{X}^{2}}{{H}_{D}} )\end{matrix} \\ \begin{matrix}{E}_{R} = {G}_{RR} {S}_{R} + {G}_{LR} {S}_{L} \\ = {G}_{RR} ( \frac{{RG}_{LL} - {LG}_{LR}}{{G}_{LL} {G}_{RR} - {G}_{LR} {G}_{RL}} ( {H}_{D} - \frac{{H}_{X}^{2}}{{H}_{D}} ) ) + \\ {G}_{LR} ( \frac{{LG}_{RR} - {RG}_{RL}}{{G}_{LL} {G}_{RR} - {G}_{LR} {G}_{RL}} ( {H}_{D} - \frac{{H}_{X}^{2}}{{H}_{D}} ) ) \\ = \frac{( {H}_{D} - \frac{{H}_{X}^{2}}{{H}_{D}} )}{{G}_{LL} {G}_{RR} - {G}_{LR} {G}_{RL}} \\ ( ( {RG}_{RR} {G}_{LL} - {LG}_{LR} {G}_{RR} + {LG}_{LR} {G}_{RR} + {RG}_{RL} {G}_{LR} ) \\ = R ( {H}_{D} - \frac{{H}_{X}^{2}}{{H}_{D}} )\end{matrix} \qquad Equation 6$$

Although, as seen from Equation 6, the amplitude or phase characteristics are altered, crosstalk components can be thoroughly cancelled out each other. Here, it is known that the phase and amplitude differences between the left and right signals become important in three-dimensional acoustic image localization. According to Equation 6, because the left signal and the right signal undergo a similar extent of transformation, the relationships of the phase and amplitude differences between the left and right signals are maintained, so that stereophonic effects can be satisfactorily obtained. That is, when the stereophonic effects that input signals R and L should present to the right and left ears, respectively, are expected, the combination of a means for canceling spatial crosstalk and a means for canceling in-casing crosstalk can produce three-dimensional acoustic image localization that has not been conventionally produced by mobile terminals.

It should be noted that in FIG. 2, a correction filter having a transfer function of H_{D}/(H_{D}²−H_{X}²) may be implemented posterior to spatial crosstalk processing, specifically, immediately posterior to the first spatial post-processing means 16RR and the second spatial post-processing means 16LL, or immediately posterior to the first summing means 4R and the second summing means 4L. This makes the signal ER reaching the first ear and the signal EL reaching the second ear turn to be input signal R and input signal L, respectively. In FIG. 2, a filter whose transfer function approximates that of H_{D}/(H_{D}²−H_{X}²) may be implemented posterior to spatial crosstalk processing, specifically, immediately posterior to the first spatial post-processing means 16RR and the second spatial post-processing means 16LL, or immediately posterior to the first summing means 4R and the second summing means 4L. This makes signals to be presented to both ears completely turn to be the input signal R and input signal L.

Moreover, in Embodiment 1 of the invention a case has been described in which reduction signals for reducing sounds that leak out into one loudspeaker from the other loudspeaker, can be obtained by processing output signals (processing-step-1-processed signals to the other loudspeaker) from the second spatial post-processing means. This invention, however, is not limited to this, but any other producing method may be feasible; the reducing signal may be produced by processing a separately produced signal.

Also, in Embodiment 1 of the invention a method of acoustic signal reproduction has been described about a case of two-channel input and two-speaker reproduction. This characteristic compensation method, however, is not limited to the case of two-channel input and two-speaker reproduction, but applicable to a method of compensating characteristics of N (N is three or more) of loudspeakers as well.

Furthermore, in addition to acoustic couplings inside the casing, in some cases, the transfer function H_{X} may include the loudspeaker and amplifier characteristics.

Furthermore, in Embodiment 1 of the invention the spatial crosstalk processing and in-casing crosstalk processing have been described as being integrated. However, each processing can also be separately implemented and independently functioned.

### Embodiment 2

While in Embodiment 1 of the invention, a first in-casing processing means 3LR and a second in-casing processing means 3RL are used as the processing step for reducing in-casing crosstalk, in Embodiment 2 of the invention, a case will be explained in which a first in-casing processing means 5RR, a second in-casing processing means 5LL, a first crossover processing means 6LR, and a second crossover processing means 6RL, are used. Note that since reproduction of the in-casing crosstalk is similar to that of Embodiment 1 of the invention in FIG. 1, the description will be omitted herein. Furthermore, since reproduction of the spatial crosstalk is also similar to that of Embodiment 1 of the invention in FIG. 1, the description will be omitted herein. Moreover, since the spatial crosstalk processing means is the same as the right portion in FIG. 2, the description will be omitted herein.

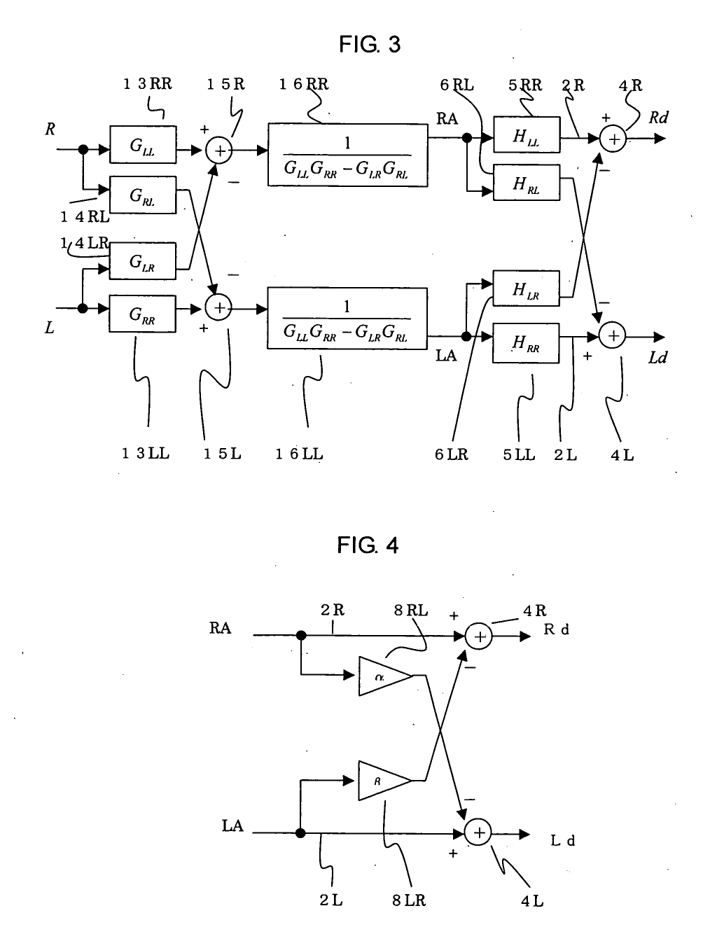

FIG. 3 is a general diagram illustrating an acoustic signal reproduction circuit for use in a mobile terminal relating to Embodiment 2 of the present invention. As shown in FIG. 3, along with the above-described spatial crosstalk processing means, the acoustic signal reproduction circuit relating to Embodiment 2 of the invention, in lieu of the first in-casing processing means 3RL and the second in-casing processing means 3LR, comprises: a first in-casing direct processing means 5RR for producing direct component to a first loudspeaker 1R, by processing an output signal RA from a first spatial post-processing means 16RR; a first crossover processing means 6LR for producing crossover component to the first loudspeaker 1R, by processing an output signal LA from a second spatial post-processing means 16LL; a first summing means 4R for outputting a driving signal RD, by summing together signals being produced through the both of the processing. Similarly, the circuit comprises: a second in-casing direct processing means 5LL for producing direct component to a second loudspeaker 1L, by processing an output signal LA from the second spatial post-processing means 16LL; a second crossover processing means 6RL for producing crossover component to the second loudspeaker 1L, by processing the output signal RA from the first spatial post-processing means 16RR; a second summing means 4L for outputting a driving signal LD, by summing together signals being produced through both the processing.

Next, the operation will be described. The output signal RA from the first spatial post-processing means 16RR is divided into two portions: one being inputted into the second in-casing crossover processing means 6RL, and the other being inputted into the first in-casing direct processing means 5RR. In a similar way, the output signal LA from the second spatial post-processing means 16LL is divided into two portions: one being inputted into the first in-casing crossover processing means 6LR, and the other being inputted into the second in-casing direct processing means. The output signal LA from the second spatial post-processing means 16LL, inputted into the first in-casing crossover processing-means 6LR is inputted, passing through a filter having a transfer function of, e.g., −H_{LR}, by the first in-casing crossover processing means 6LR, into the summing means 4R. The output signal RA from the first spatial post-processing means 16RR, inputted into the first in-casing direct processing means 5RR, is inputted, passing through a filter having a transfer function of, e.g., −H_{LL}, by the first in-casing direct processing means 5RR, into the first summing means 4R. This first summing means 4R sums both signals together, producing the driving signal RD. Similarly, the output signal RA from the first spatial post-processing means 16RR, inputted into the second in-casing crossover processing means 6RL, is inputted, passing through a filter having a transfer function of, e.g., −H_{RL}, by the first in-casing crossover processing means 6RL, into the summing means 4R. The output signal LA from the second spatial post-processing means 16LL, inputted into the second in-casing direct processing means 5LL, is inputted passing through a filter having a transfer function of, e.g., −H_{RR}, by the second in-casing direct processing means 5LL, into the second summing means 4L. The second summing means 4L sums both signals together, producing the driving signal LD. The driving signals RD and LD are given as Equation 7.

$$Rd = \frac{{RG}_{LL} - {LG}_{LR}}{{G}_{LL} {G}_{RR} - {G}_{LR} {G}_{RL}} {H}_{LL} - \frac{{LG}_{RR} - {RG}_{RL}}{{G}_{LL} {G}_{RR} - {G}_{LR} {G}_{RL}} \cdot {H}_{LR} \\ Ld = \frac{{LG}_{RR} - {RG}_{RL}}{{G}_{LL} {G}_{RR} - {G}_{LR} {G}_{RL}} {H}_{RR} - \frac{{RG}_{LL} - {LG}_{LR}}{{G}_{LL} {G}_{RR} - {G}_{LR} {G}_{RL}} \cdot {H}_{RL} \qquad Equation 7$$

When the first and the second loudspeakers 1R and 1L are driven by the driving signals RD and LD, respectively, each produced by means of the above processing, referring to FIG. 1, the loudspeaker's emission signals SR and SL being emitted from the first and the second loudspeakers 1R and 1L, respectively, are given as Equation 8.

$$\begin{matrix}{S}_{R} = {RdH}_{RR} + {LdH}_{LR} \\ = ( \frac{{RG}_{LL} - {LG}_{LR}}{{G}_{LL} {G}_{RR} - {G}_{LR} {G}_{RL}} ) ( {H}_{LL} {H}_{RR} - {H}_{LR} {H}_{RL} )\end{matrix} \\ \begin{matrix}{S}_{L} = {LdH}_{LL} + {RdH}_{RL} \\ = ( \frac{{LG}_{RR} - {RG}_{RL}}{{G}_{LL} {G}_{RR} - {G}_{LR} {G}_{RL}} ) ( {H}_{LL} {H}_{RR} - {H}_{LR} {H}_{RL} )\end{matrix} \qquad Equation 8$$

Because the loudspeaker's emission signals SR and SL undergo influences of such as acoustic couplings, the signals ER and EL arriving at the first and the second ears, respectively, are given as Equation 9.

$$\begin{matrix}{E}_{R} = {G}_{RR} {S}_{R} + {G}_{LR} {S}_{L} \\ = {G}_{RR} + ( \frac{{RG}_{LL} - {LG}_{LR}}{{G}_{LL} {G}_{RR} - {G}_{LR} {G}_{RL}} ( {H}_{LL} {H}_{RR} - {H}_{LR} {H}_{RL} ) ) + \\ {G}_{LR} ( \frac{{LG}_{RR} - {RG}_{RL}}{{G}_{LL} {G}_{RR} - {G}_{LR} {G}_{RL}} ( {H}_{LL} {H}_{RR} - {H}_{LR} {H}_{RL} ) ) \\ = \frac{( {H}_{LL} {H}_{RR} - {H}_{LR} {H}_{RL} )}{{G}_{LL} {G}_{RR} - {G}_{LR} {G}_{RL}} \\ ( ( {RG}_{RR} {G}_{LL} - {LG}_{LR} {G}_{RR} + {LG}_{LR} {G}_{RR} - {RG}_{RL} {G}_{LR} ) \\ R ( {H}_{LL} {H}_{RR} - {H}_{LR} {H}_{RL} )\end{matrix} \\ \begin{matrix}{E}_{L} = {G}_{LL} {S}_{L} + {G}_{RL} {S}_{R} \\ = {G}_{LL} ( \frac{{LG}_{RR} - {RG}_{RL}}{{G}_{LL} {G}_{RR} - {G}_{LR} {G}_{RL}} ( {H}_{LL} {H}_{RR} - {H}_{LR} {H}_{RL} ) ) + \\ {G}_{LR} ( \frac{{RG}_{LL} - {lG}_{LR}}{{G}_{LL} {G}_{RR} - {G}_{LR} {G}_{RL}} ( {H}_{LL} {H}_{RR} - {H}_{LR} {H}_{RL} ) ) \\ = \frac{( {H}_{LL} {H}_{RR} - {H}_{LR} {H}_{RL} )}{{G}_{LL} {G}_{RR} - {G}_{LR} {G}_{RL}} \\ ( ( {LG}_{RR} {G}_{LL} - {RG}_{RL} {G}_{LL} + {RG}_{RL} {G}_{LL} - {LG}_{RL} {G}_{LR} ) \\ = L ( {H}_{LL} {H}_{RR} - {H}_{LR} {H}_{RL} )\end{matrix} \qquad Equation 9$$

As seen from Equation 9, while those signals undergo transformation in the amplitude or phase characteristics, crosstalk components can be thoroughly cancelled out each other. Here, it is known that the phase and amplitude differences between the left and right signals are important in three-dimensional acoustic image localization. According to Equation 9, because the left and the right signals undergo a similar extent of transformation, the relationships of the phase and amplitude differences between the left and right signals are maintained, leading to satisfactory stereophonic effects being obtained. Namely, when the input signals R and L are expected to produce stereophonic effects at both ears, the combination of a means for canceling spatial crosstalk and a means for canceling in-casing crosstalk can achieve three-dimensional sound image localization that has not been conventionally achieved in mobile terminals. It should be noted that in FIG. 3, a correction filter, not shown, having a transfer function of 1/(H_{LL}H_{RR}−H_{LR}H_{RL}), may be implemented posterior to spatial crosstalk processing, specifically, immediately posterior to the first spatial post-processing means 16RR and the second spatial post-processing means 16LL, or immediately posterior to the first summing means 4R and the second summing means 4L. This makes the signals ER and EL reaching the first and the second ears turn to be the input signal R and the input signal L, respectively. In FIG. 3, a filter having a transfer function approximate to that of 1/(H_{LL}H_{RR}−H_{LR}H_{RL}), not shown, may be implemented posterior to spatial crosstalk processing, specifically, immediately posterior to the first spatial post-processing means 16RR and the second spatial post-processing means 16LL, or immediately posterior to the first summing means 4R and the second summing means 4L. This makes the signals ER and EL reaching the first and the second ears, turn to be the input signal R and the input signal L, respectively.

Furthermore, when the transfer functions H_{RL} and H_{LR}, and the transfer functions H_{RR} and H_{LL} are common to each other, or when those are so approximate to each other as assumed to be common to each other, it can be assumed that H_{LR}=H_{RL}=H_{X}, H_{RR}=H_{LL}=H_{D}. Thus, the transfer function of the first and the second in-casing direct processing means 5RR and 5LL, respectively, can be made to be H_{D}. Similarly, the transfer function of the first and the second in-casing crossover processing means 6LR and 6RL, respectively, can be made to be −H_{X}. In this case, the signals ER and EL arriving at the first and the second ears, turn to be the input, signal R and the input signal L, respectively.

$$\begin{matrix}{E}_{R} = {G}_{RR} {S}_{R} + {G}_{LR} {S}_{L} \\ = {G}_{RR} ( \frac{{RG}_{LL} - {LG}_{LR}}{{G}_{LL} {G}_{RR} - {G}_{LR} {G}_{RL}} ( {H}_{D}^{2} - {H}_{X}^{2} ) ) + \\ {G}_{LR} ( \frac{{LG}_{RR} - {RG}_{RL}}{{G}_{LL} {G}_{RR} - {G}_{LR} {G}_{RL}} ( {H}_{D}^{2} - {H}_{X}^{2} ) ) \\ = \frac{( {H}_{D}^{2} - {H}_{X}^{2} )}{{G}_{LL} {G}_{RR} - {G}_{LR} {G}_{RL}} \\ ( ( {RG}_{RR} {G}_{LL} - {LG}_{LR} {G}_{RR} + {LG}_{LR} {G}_{RR} - {RG}_{RL} {G}_{LR} ) \\ = R ( {H}_{D}^{2} - {H}_{X}^{2} )\end{matrix} \qquad Equation 10$$

$$\begin{matrix}{E}_{L} = {G}_{LL} {S}_{L} + {G}_{RL} {S}_{R} \\ = {G}_{LL} ( \frac{{LG}_{RR} - {RG}_{RL}}{{G}_{LL} {G}_{RR} - {G}_{LR} {G}_{RL}} ( {H}_{D}^{2} - {H}_{X}^{2} ) ) + \\ {G}_{RL} ( \frac{{RG}_{LL} - {LG}_{LR}}{{G}_{LL} {G}_{RR} - {G}_{LR} {G}_{RL}} ( {H}_{D}^{2} - {H}_{X}^{2} ) ) \\ = \frac{( {H}_{D}^{2} - {H}_{X}^{2} )}{{G}_{LL} {G}_{RR} - {G}_{LR} {G}_{RL}} \\ ( ( {LG}_{RR} {G}_{LL} - {RG}_{RL} {G}_{LL} + {RG}_{RL} {G}_{LL} + {LG}_{RL} {G}_{LR} ) \\ = L ( {H}_{D}^{2} - {H}_{X}^{2} )\end{matrix} \qquad Equation 11$$

Therefore, for instance, when loudspeakers are arranged bilaterally symmetrically or up-down symmetrically inside the casing, manufacturing costs of signal processing means can be effectively reduced by providing commonality to the direct processing means 5 or the crossover processing means 6.

Moreover, in FIG. 3, a correction filter having the transfer function of H_{D}²/(H_{D}²−H_{X}²) may be implemented posterior to spatial crosstalk processing, specifically, immediately posterior to the first spatial post-processing means 16RR and the second spatial post-processing means 16LL, or immediately posterior to the first summing means 4R and the second summing means 4L. This makes the signals ER and EL arriving at the first and the second ears turn to be the input signal R and the input signal L, respectively. Referring to FIG. 3, a filter whose transfer function approximates to that of 1/(H_{D}²−H_{X}²) may be implemented posterior to spatial crosstalk processing, specifically, immediately posterior to the first spatial post-processing means 16RR and the second spatial post-processing means 16LL, or immediately posterior to the first summing means 4R and the second summing means 4L. This makes the signals ER and EL arriving at the first and the second ears turn to be the input signal R and the input signal L, respectively.

Here, in Embodiment 2 of the invention some of the explanations have been omitted by applying same symbols to the portions identical to or equivalent with those in Embodiment 1 of the invention, and only portions different from Embodiment 1 of the invention have been explained.

### Embodiment 3

Although in Embodiment 1 of the invention, the first in-casing processing means 3LR and the second in-casing processing means 3RL have been used as the processing step of reducing in-casing crosstalk, in Embodiment 1 of the invention a case is explained in which a first in-casing multiplication processing means 8LR, a second in-casing multiplication processing means 8RL, as will be hereinafter described, are used.

Note that since the reproduction of the in-casing crosstalk is similar to that as shown in FIG. 1 in Embodiment 1 of the invention, the description will be omitted herein. Furthermore, since the reproduction of the spatial crosstalk is also similar to that as shown in FIG. 1 of Embodiment 1, the description will be omitted herein. Moreover, since the spatial crosstalk processing is the same as the left part of FIG. 2, the description will be omitted herein.

FIG. 4 is a general diagram illustrating an acoustic signal reproduction circuit for use in a mobile terminal relating to Embodiment 3 of the present invention. As illustrated in FIG. 4, the acoustic signal reproduction circuit in this embodiment of the invention, comprises: the first in-casing multiplication processing means 8LR for producing, by processing the output signal LA from the second spatial post-processing means 16LL, crossover components to the first loudspeaker 1R; the second multiplication processing means 8RL for producing, by processing the output signal RA from the first spatial post-processing means 16RR, crossover components to the second loudspeaker 1L.

Next, the operation will be described. The output signal RA from the first spatial post-processing means 16RR is divided into two portions: one being inputted into the second in-casing multiplication processing means 8RL, and the other being inputted into the first summing means 4R, as a direct component. Similarly, the output signal LA from the second spatial post-processing means 16LL is divided into two portions: one being inputted into the first in-casing multiplication processing means 8LR, and the other being inputted into the second summing means 4L, as a direct component.

The output signal LA from the second spatial post-processing means 16LL is inputted into the summing means 4R, through the first in-casing multiplication processing means 8LR, e.g., a filter having a transfer function of multiplying by a scalar value β less than one, and reversing the arithmetic sign. The first summing means 4R produces the driving signal RD by summing together the output signal from the first in-casing multiplication processing means 8LR, and the output signal RA from the first spatial post-processing 16RR. Similarly, the output signal RA from the second spatial post-processing means 16RR is inputted into the second summing means 4L, through the first in-casing multiplication processing means 8LR, e.g., a filter having a transfer function of multiplying by a scalar value β less than one, and reversing the arithmetic sign. The second summing means 4L produces the driving signal LD by summing together an output signal from the second in-casing multiplication processing means 8RL, and the output signal LA from the first spatial post-processing 16LL.

When the first and the second loudspeakers 1R and 1L are driven by the driving signals RD and LD each produced through the above processing, respectively, the loudspeaker's emission signal SR being emitted from loudspeaker R, referring to FIG. 1, is given as Equation 12.

$$\begin{matrix}{S}_{R} = {RdH}_{RR} + {LdH}_{LR} \\ = ( RA - β LA ) {H}_{RR} + ( LA - α RA ) {H}_{LR} \\ = RA ( {H}_{RR} - α {H}_{LR} ) - LA ( β {H}_{RR} - {H}_{LR} )\end{matrix} \qquad Equation 12$$

Further, the loudspeaker's emission signal SL being emitted from the second loudspeaker 1L is given as Equation 13.

$$\begin{matrix}{S}_{L} = {LdH}_{LL} + {RdH}_{RL} \\ = ( LA - α RA ) {H}_{LL} + ( RA - β LA ) {H}_{RL} \\ = LA ( {H}_{LL} - β {H}_{RL} ) - RA ( α {H}_{LL} - {H}_{RL} )\end{matrix} \qquad Equation 13$$

Next, the optimal coefficient β to be applied to the first in-casing multiplication processing means 8LR will be determined. Namely, in order for the loudspeaker's emission signal SR from the first loudspeaker 1R to enhance separation of the output signal LA from the second spatial post-processing means 16LL, it can be seen that the value may be determined such that the value of (βH_{RR}−H_{LR}) approximates to zero most. In other words, the optimal coefficient β* is given by Equation 14.

$${β}^{*} = {arg min}_{β} \vert ( β {H}_{RR} - {H}_{LR} ) \vert \qquad Equation 14$$

This shows that in the first in-casing multiplication processing means 8LR, by multiplying by the optimal coefficient β* the output signal LA from the second spatial post-processing means 16LL, only an RA component in the driving signal RD is emitted, and the other signal components (LA components) is cancelled or diminished. In a similar fashion, the optimal coefficient α to be applied to the second in-casing multiplication processing means 8RL will be determined. Namely, in order for the loudspeaker's emission signal SL from the second loudspeaker 1L to enhance separation from the output signal RA from the first spatial post-processing means 16RR, it can be seen that the value may be determined such that the value of (α*H_{LL}−H_{RL}) approximates to zero most. That is, the optimal coefficient α* is given by Equation 15.

$${α}^{*} = {arg min}_{α} \vert ( α {H}_{LL} - {H}_{RL} ) \vert \qquad Equation 15$$

This shows that in the second in-casing multiplication processing means 8RL, by multiplying by the optimal coefficient β* the output signal RA from the second spatial post-processing means 16RR, only an RA component in the driving signal LD is emitted, and the other signal components (RA components) is cancelled or diminished. From what has been described above, by determining coefficients α* and β*, and applying the α* and β* to the second and the first in-casing multiplication processing means 8RL and 8LR, respectively, in-casing crosstalk components can be cancelled and signals from which the in-casing acoustic couplings has been cancelled can be reproduced while the amplitude and phase undergo characteristics changes. Here, it is known that the phase and amplitude differences between left and right signals are important in three-dimensional acoustic image localization. Namely, when input signals R and L are expected to present stereophonic effects at the left and right ears, the combination of a means for canceling spatial crosstalk and a means for canceling the above-described in-casing crosstalk can produce three-dimensional sound image localization that has not been conventionally produced in mobile terminals.

Moreover, the above-described multiplication processing means 8 are inexpensively manufactured, resulting in loudspeaker characteristic compensation being effectively realized.

Note that in this Embodiment of the invention the same description has been omitted by applying the same symbols to the portions identical to or equivalent with those in Embodiment 1 of the invention, but described only portions different from Embodiment 1 of the invention.

### Embodiment 4

While in Embodiment 1 of the invention, the first in-casing processing means 3LR and the second in-casing processing means 3RL are used as the processing step of reducing in-casing crosstalk, in this embodiment of the invention a case will be described in which a first subband division processing means 9LR, a first subband processing means 10LR, a first subband synthesis processing means 11LR, a second subband division processing means 6RL, and a second subband synthesis processing means 11RL, are used.

Note that since reproduction of the in-casing crosstalk is similar to that as shown in FIG. 1 in Embodiment 1 of the invention, the description will be omitted herein. In addition, since reproduction of spatial crosstalk is also similar to that as shown in FIG. 1 in Embodiment 1 of the invention, the description will be omitted herein. Further, since the spatial crosstalk processing means is the same as the left part of FIG. 2, the description will be omitted herein.

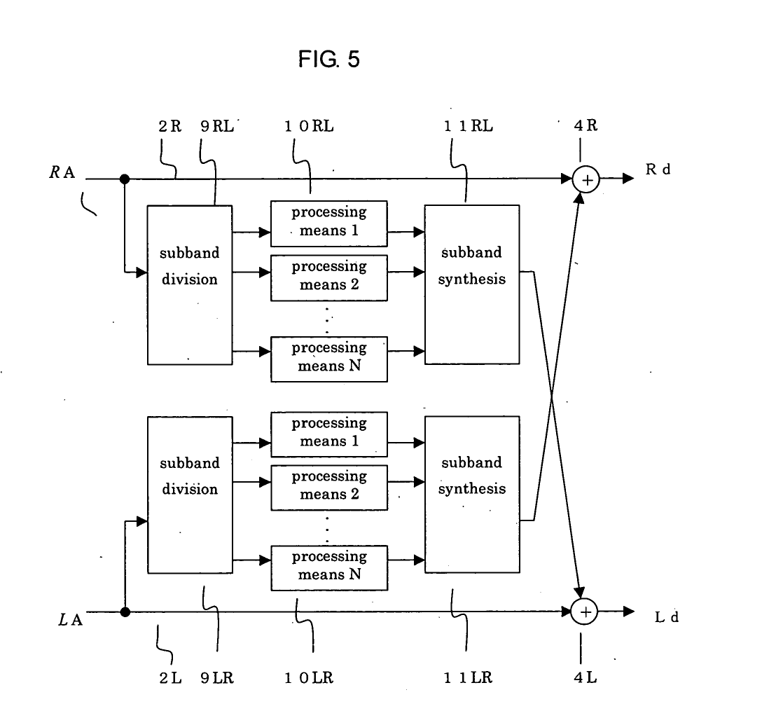

FIG. 5 is a general diagram illustrating an acoustic signal reproduction circuit for use in a mobile terminal relating to Embodiment 4 of the invention. As illustrated in FIG. 5, the acoustic signal reproduction circuit in this embodiment of the invention, comprises: the first subband division means 9LR, the first subband means 10LR, the first subband synthesis means 11LR for producing, by processing the output signal LA from the second spatial post-processing means 16LL, crossover components to the first loudspeaker 1R; the second subband division means 9RL, the first subband means 10RL, the first subband synthesis means 11RL for producing, by processing the output signal RA from the first spatial post-processing means 16RR, crossover-components to the second loudspeaker 1L.

Next, the operation will be described. The output signal RA from the second spatial post-processing means 16LL is inputted into the second summer 4L, and the first subband division means 9RL. The subband division means 9LR divides the signal LA into K subbands, on a frequency basis. Signals divided by the subband division means 9LR 1 is assigned to be signals L1, L2 . . . LK, from the low band thereof. The signal L1 is inputted into the first subband processing means 10LR1. The signal L2 is inputted into the first subband processing means 10LR2, subsequently, the signals up to LK being inputted into the corresponding processing means 10LRj (j=1, 2 . . . K). The first subband processing means 10LRj processes and outputs the inputted signal Lj, for example, extracts a transfer function equivalent to that of a band corresponding to the band j in the transfer function of −H_{LR}/H_{RR}, to process the inputted signal Lj, further, implements processing to apply the signal to a transfer function multiplied by a certain coefficient yj. A processed signal outputted from the first subband processing means 10LRj is synthesized by the first subband synthesis means 11LR, being inputted into the first summing means 4R. The first summing means 4R outputs the driving signal RD for driving the first loudspeaker 1R, by summing together the output signal RA from the first spatial post-processing means 16RR, and the output signal from the first subband synthesis processing means 11LR.

Similarly, the output signal RA from the first spatial post-processing means 16RR is inputted into the first summer 4R and the second subband division means 9RL. The subband division means 9RL divides the signal RA into K subbands, on the frequency basis. Signals divided by the subband division means 9RL is assigned to be signals R1, R2 . . . RK, in the frequency order from the lower band thereof. The signal R1 is inputted into the second subband overall processing means 10RL1. The signal R2 is inputted into the second subband processing means 10RL2, subsequently, the signals up to RK being inputted into the corresponding processing means 10LRj (j=1, 2 . . . K). The second subband processing means 10RLj processes and outputs the inputted signal Lj, for example, extracts a transfer function equivalent to that of band corresponding to the band j in the transfer function of, −H_{RL}/H_{LL} and processes the inputted signal Rj, a n d further, implements processing to apply the signal to a transfer function multiplied by a certain coefficient yj. A processed signal outputted from the second subband processing means 10RLj is synthesized by the second subband synthesis means 11RL, being inputted into the second summing means 4L. The second summing means 4L outputs the driving signal LD for driving the second loudspeaker 1L, by summing together the output signal LA from the second spatial post-processing means 16LL, and an output signal from the second subband synthesis processing means 11RL.

From the above-described processing, when yj is assumed to be one throughout the entire band, the same effect as in Embodiment 1 of the invention can be obtained. Changing of yj can vary on a band basis the degree of processing, e.g, setting the low-band signal yj at a larger value allows low-band components of the output signal to be emphasized. Furthermore, when, by combining in-casing crosstalk cancellation processing and spatial crosstalk cancellation processing, as described above, input signals R and L are expected to present stereophonic effects at the left and right ears, the combination of a means for canceling spatial crosstalk and a means for canceling the above-described in-casing crosstalk, can produce three-dimensional sound image localization that has not been conventionally realized in mobile terminals.

Here, in this embodiment of the invention the same description has been omitted by applying same symbols to the portions identical to or equivalent with those in Embodiment 1 of the invention of the invention, but described only portions different from the above-described embodiments of the invention.

### Embodiment 5

While in Embodiment 1 of the invention, the first in-casing processing means 3LR and the second in-casing processing means 3RL are used as the processing step of reducing in-casing crosstalk, in this embodiment of the invention a case will be described in which a first low-pass means and a second low-pass means are used, which are not shown but will be hereinafter described. It should be noted that this embodiment of the invention is equal to that in which the first in-casing processing means 3LR and the second in-casing processing means in FIG. 2 have been replaced with the first low-pass means and the second low-pass means, respectively.

Note that since reproduction of the in-casing crosstalk is similar to that as shown in FIG. 1 in Embodiment 1 of the invention, the description will be omitted herein. Furthermore, since reproduction of the spatial crosstalk is also similar to that as shown in FIG. 1 in Embodiment 1 of the invention, the description thereof will be omitted herein. Moreover, the spatial crosstalk processing means is the same as the left part of FIG. 2, thus, the description thereof will be omitted herein. An acoustic signal reproduction circuit in this embodiment of the invention comprises: the first low-pass means for producing, by processing the output signal LA of the second spatial post-processing means 16LL, crossover components to the first loudspeaker 1R; the second low-pass means for producing, by processing output signal RA from the first spatial post-processing means 16RR, crossover components to the second loudspeaker 1L.

Next, the operation will be described. The output signal LA from the second spatial post-processing means 16LL is inputted into the second summer 4L, and the first low-pass means. The first low-pass means implements processing such that signals passing through an LPF (low-pass filter) is characterized by a transfer function of e.g., −H_{LR}/H_{RR}. The processed signal outputted from the first low-pass means is inputted into the first summing means. The first summing means 4R outputs the driving signal RD for driving the first loudspeaker 1R, by summing together the output signal RA from the first spatial post-processing means 16RR, and an output signal from the first low-pass means. Similarly, the output signal RA from the first spatial post-processing means 16RR is inputted into the first summer 4R, and the second low-pass means. The second low-pass means implements processing such that signals passing through an LPF (low-pass filter) are characterized by a transfer function of e.g., −H_{RL}/H_{LL}. The output signal from the second processed low-pass means is inputted into the second summing means. The second summing means outputs the driving signal LD for driving the second loudspeaker 1R, by summing together the output signal LA from the second spatial post-processing means 16LL, and an output signal, from the second low-pass means.

According to this embodiment of the invention, only low-band signal components undergo crosstalk cancellation processing. Therefore, a sense of emphasizing high-band signal components caused by phase mismatch signals with each other for canceling high-band signal components, can be reduced, resulting in an effect of allowing for comfortably receiving acoustic signals. Furthermore, when input signals R and L are expected to present stereophonic effects at both right and left ears, the combination of a means for canceling spatial crosstalk and a means for canceling in-casing crosstalk can produce three-dimensional sound image localization that has not been conventionally produced in mobile terminals.

It should be noted that this embodiment of the invention the same description has been omitted by applying same symbols to the portions identical to or equivalent with those in Embodiment 1 of the invention, but described only portions different from Embodiment 1 of the invention. Also, the technology described in this embodiment of the invention is applicable to those other than Embodiment 1 of the invention as well.

### Embodiment 6

While in Embodiment 1 of the invention, the first in-casing processing means 3LR and the second in-casing processing means 3RL are used as the processing step of reducing in-casing crosstalk, in this embodiment of the invention a case will be described in which a correlation computational means 23, a control means 24, a first switch 25LRa, a first switch 25LRb, a second switch 25RLa, a second switch 25RLb, a first signal processing means 26LR, and a first signal processing means 26RL, are used.

Note that since reproduction of the in-casing crosstalk is similar to that as shown in FIG. 1 in Embodiment 1 of the invention, the description will be omitted herein. In addition, since reproduction of the spatial crosstalk is also similar to that as shown in FIG. 1 in Embodiment 1 of the invention, the description will be omitted herein. Furthermore, since the spatial crosstalk processing means is the same as the left part of FIG. 2, the description will be omitted herein.

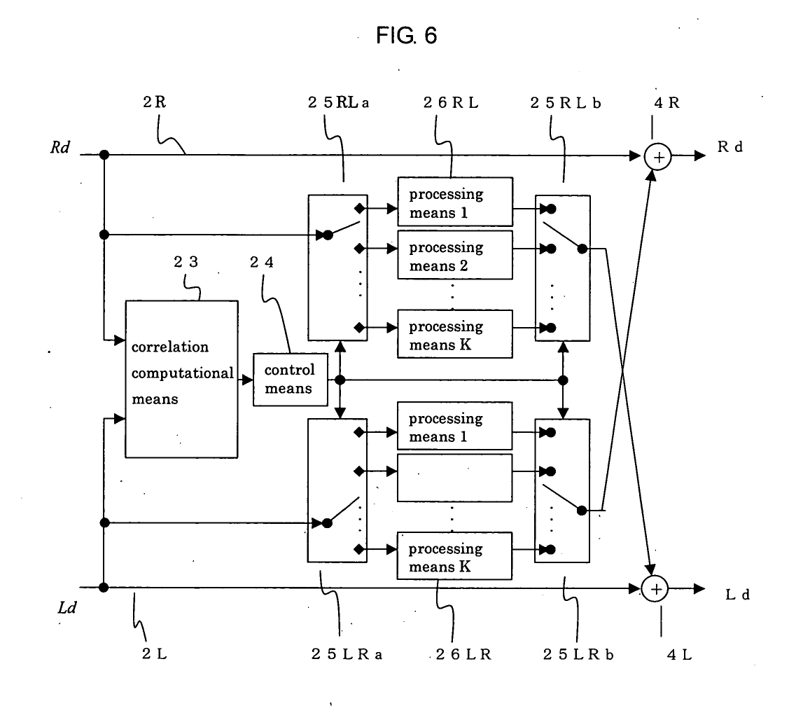

FIG. 6 is a general diagram illustrating an acoustic signal reproduction circuit for use in a mobile terminal relating to Embodiment 6 of the present invention. As illustrated in FIG. 6, the acoustic signal reproduction circuit relating to this embodiment of the invention, comprises: the correlation computational means 23 for computing correlation for each frequency component of output the signals RA and LA from the first and the second spatial post-processing means 16RR and 16LL, respectively; the control means 24 for controlling the first and the second switches 25LR and 25RL, on the basis of correlation between signals LA and RA; and the first and the second signal processing means 26LR and 26RL for processing inputted signals. The first switch 25LR is connected to any one of the first signal processing means 26LR1 through 26LRK, the second switch 25RL to any one of the second signal processing means 26RL1 through 26RLK.

Next, the operation will be described. The output signal RA from the first spatial post-processing means 16RR is inputted into the first summer 4R, the second switch 25RLa, and the correlation computational means 23. The output signal LA from the second spatial post-processing means 16LL is inputted into the second summer 4L, the first switch 25LRa, and the correlation computational means 23. The correlation computational means 23 computes correlation between output signals RA and LA on a frequency component basis, and inputs to the control means 23 the computed results. The control means 24 where the computed results have been inputted switches the first switches 25LRa and 25LRb, and the second switches 25RLa and 25RLb, in response to the correlation between the signals RA and LA for each frequency. When, for instance, a certain band has a high correlation, the first switch is controlled to connect to the signal processing means 26RL or the second signal processing means 26LR that reduces to zero signal intensity corresponding to the band. The first signal processing means 26RL may implement processing to characterize the signal to a transfer function of, e.g., −H_{LR}/H_{RR} after reducing to zero the signal intensity of a particular band. The second signal processing means 26LR may implement processing to characterize the signal to a transfer function of, e.g., −H_{RL}/H_{LL} after reducing to zero the signal intensity of a particular band.

Here, high correlation in a certain band suggests that signal components of the signals LA and RA in a particular band are approximately in common-mode with each other. At this moment, processing for canceling acoustic couplings leads to summing together an original signal and a proximate phase-reversed signal from the original one, thus resulting in audible deterioration being generated due to reduced components in the highly correlated bands. According to the embodiment described above of the invention, however, because zero is added to the signal components of the highly correlated bands, effects can be produced in that audible deterioration as described above will not be generated. Furthermore, because common-mode components are sounds that are supposed to be located in the center, a listener can acquire satisfactory acoustic images without canceling the acoustic couplings in regard to the common-mode components. Moreover, when input signals R and L are expected to present stereophonic effects at both ears, the combination of a means for canceling spatial crosstalk and a means for canceling in-casing crosstalk can produce three-dimensional sound image localization that has not been conventionally produced in mobile terminals.

It should be noted that in this embodiment of the invention the same description has been omitted by applying same symbols to the portions identical to or equivalent with those in Embodiment 1 of the invention, but described only portions different from Embodiment 1 of the invention.

### Embodiment 7

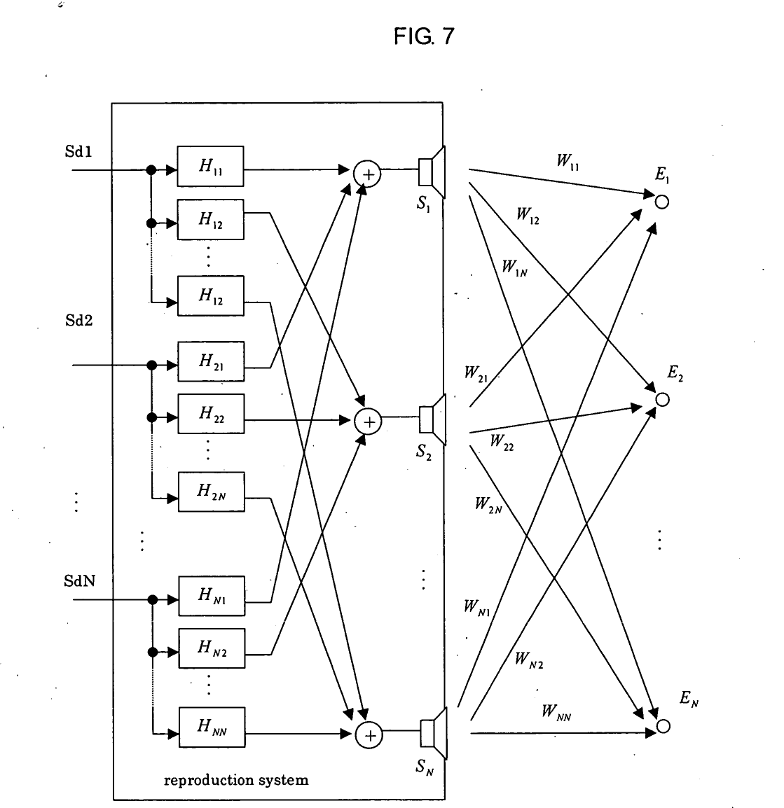

FIG. 7 illustrates a modeling of a reproduction system including a plurality of loudspeakers. In FIG. 7, the left part of which is a modeling of a reproduction system inside the casing, being referred to as in-casing reproduction system. The right part, on the other hand, is a modeling of a reproduction system in space (outside the casing); being referred to as spatial reproduction system. As shown in the left part of FIG. 7, because of a loudspeaker-rear air chamber being shared by a quantity N of loudspeakers; the in-casing reproduction system produces acoustic coupling with one another inside the casing. This acoustic coupling is referred to as in-casing crosstalk characteristics. Furthermore, in the reproduction system, amplifier/speaker characteristics that generate when signals inputted into a channel of the reproduction system are directly transmitted and emitted from a corresponding loudspeaker, are referred to as in-casing direct characteristics. Similarly, as shown in the right part of FIG. 7, this spatial reproduction system produces a phenomenon in that sound waves being reproduced from one loudspeaker, while supposed to be conveyed to a listener's ear, couple at the other ear and leak thereinto. This acoustic coupling is referred to as spatial crosstalk characteristics. Moreover, in the reproduction system, when sound waves being reproduced from the one loudspeaker, are directly transmitted to the ear of a listener to whom the sound waves are supposed to be conveyed, the characteristics are referred to as spatial direct characteristics

In the left part of FIG. 7, given that a signal for driving an i-th loudspeaker as the direct component, in the reproduction system, is a driving signal SDi; in the reproduction system, a signal being emitted from the i-th loudspeaker, a loudspeaker's emission signal Si; a transfer function (in-casing direct characteristic) for the driving signal SDi of an i-th channel, as altered by loudspeaker and amplifier characteristics, etc. until emitted from the i-th loudspeaker, a transfer function Hii; and a transfer function (in-casing crosstalk characteristic) for the driving signal SDi of the i-th channel as altered by acoustic couplings until emitted from the j-th loudspeaker, a transfer function Hij. Similarly, in the right part of FIG. 7, given that a transfer function (spatial direct characteristic) for the loudspeaker's emission signal Si, as being via space until arriving at an i-th listener's ear is Wᵢᵢ; a transfer function (spatial crosstalk characteristic) for the loudspeaker's emission signal Si, as altered by acoustic couplings until arriving at the listener's j-th ear is Wᵢⱼ. Loudspeaker's emission signals S, driving signals SD, an in-casing transfer function H, and a spatial transfer function W, as shown in FIG. 7 are given as Equation 16.

$$S = {[ {S}_{1} , {S}_{2} , … , {S}_{N} ]}^{T} \\ Sd = {[ {Sd}_{1} , {Sd}_{2} , … , {Sd}_{N} ]}^{T} \\ H = [ \begin{matrix}{H}_{11} , {H}_{21} , … , {H}_{N 1} \\ {H}_{12} , {H}_{22} , … , {H}_{N 2} \\ … \\ {H}_{1 N} , {H}_{2 N} , … , {H}_{NN}\end{matrix} ] \\ W = [ \begin{matrix}{W}_{11} , {W}_{21} , … , {W}_{N 1} \\ {W}_{12} , {W}_{22} , … , {W}_{N 2} \\ … \\ {W}_{1 N} , {W}_{2 N} , … , {W}_{NN}\end{matrix} ] \qquad Equation 16$$

The emitting signals S and signals E arriving at the listener's ears, in this case, are each expressed by Equation 17.

$$\begin{matrix}S = HSd \\ = [ \begin{matrix}{H}_{11} {Sd}_{1} + {H}_{21} {Sd}_{2} + … + {H}_{N 1} {Sd}_{N} \\ {H}_{12} {Sd}_{1} + {H}_{22} {Sd}_{2} + … + {H}_{N 2} {Sd}_{N} \\ … \\ {H}_{1 N} {Sd}_{1} + {H}_{2 N} {Sd}_{2} + … + {H}_{NN} {Sd}_{N}\end{matrix} ]\end{matrix} \\ \begin{matrix}E = WHSd \\ = WS \\ = [ \begin{matrix}{W}_{11} , {W}_{21} , … , {W}_{N 1} \\ {W}_{12} , {W}_{22} , … , {W}_{N 2} \\ … \\ {W}_{1 N} , {W}_{2 N} , … , {W}_{NN}\end{matrix} ] [ \begin{matrix}{H}_{11} {Sd}_{1} + {H}_{21} {Sd}_{2} + … + {H}_{N 1} {Sd}_{N} \\ {H}_{12} {Sd}_{1} + {H}_{22} {Sd}_{2} + … + {H}_{N 2} {Sd}_{N} \\ … \\ {H}_{1 N} {Sd}_{1} + {H}_{2 N} {Sd}_{2} + … + {H}_{NN} {Sd}_{N}\end{matrix} ] \\ = [ \begin{matrix}{W}_{11} ( {H}_{11} {Sd}_{1} + {H}_{21} {Sd}_{2} + … + {H}_{N 1} {Sd}_{N} ) + … + {W}_{N 1} ( {H}_{1 N} {Sd}_{1} + {H}_{2 N} {Sd}_{2} + … + {H}_{NN} {Sd}_{N} ) \\ {W}_{12} ( {H}_{11} {Sd}_{1} + {H}_{21} {Sd}_{2} + … + {H}_{N 1} {Sd}_{N} ) + … + {W}_{N2} ( {H}_{1 N} {Sd}_{1} + {H}_{2 N} {Sd}_{2} + … + {H}_{NN} {Sd}_{N} ) \\ … \\ {W}_{1 N} ( {H}_{11} {Sd}_{1} + {H}_{21} {Sd}_{2} + … + {H}_{N 1} {Sd}_{N} ) + … + {W}_{NN} ( {H}_{1 N} {Sd}_{1} + {H}_{2 N} {Sd}_{2} + … + {H}_{NN} {Sd}_{N} )\end{matrix} ]\end{matrix} \qquad Equation 17$$

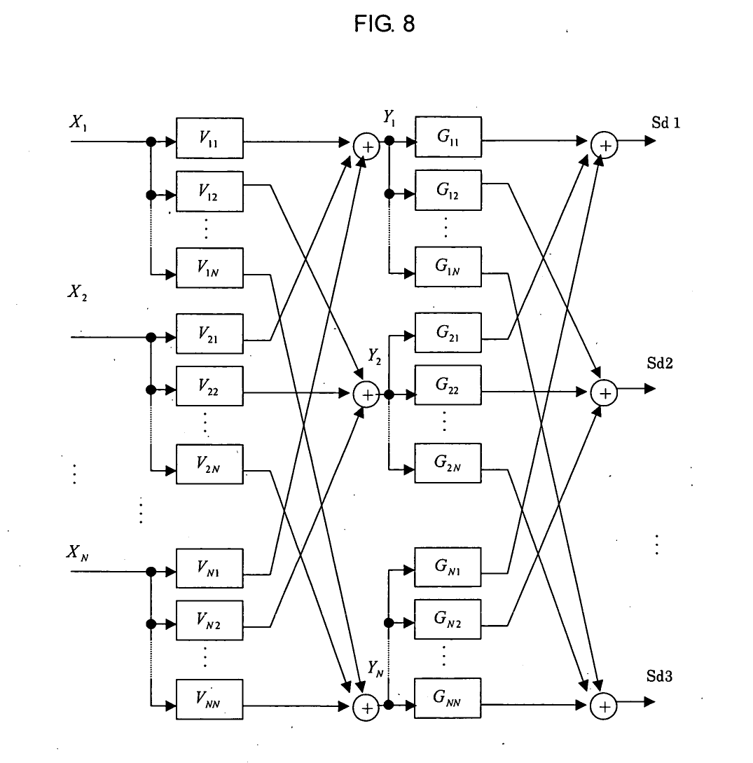

Equation 17 shows that the signals E arriving at the listener's ears are complex signals having the in-casing crosstalk components and the spatial crosstalk components. FIG. 8 is a conceptual diagram illustrating a crosstalk canceller for canceling crosstalk components as shown in FIG. 7. In FIG. 8, Xi, Vij, and Gij are input signals, in-casing crosstalk canceling filters, and spatial crosstalk canceling filters, respectively. These are expressed by Equation 18.

$$X = {[ {X}_{1} , {X}_{2} , … , {X}_{N} ]}^{T} \\ V = [ \begin{matrix}{V}_{11} , {V}_{21} , … , {V}_{N 1} \\ {V}_{12} , {V}_{22} , … , {V}_{N 2} \\ … \\ {V}_{1 N} , {V}_{2 N} , … , {V}_{NN}\end{matrix} ] \\ G = [ \begin{matrix}{G}_{11} , {G}_{21} , … , {G}_{N 1} \\ {G}_{12} , {G}_{22} , … , {G}_{N 2} \\ … \\ {G}_{1 N} , {G}_{2 N} , … , {G}_{NN}\end{matrix} ] \qquad Equation 18$$

The filtering characteristics of G and V in Equation 18 are expressed as, e.g., Equation 19.

$$V = [ \begin{matrix}{W}_{11} , {W}_{21} , … , {W}_{1 N} \\ {W}_{21} , {W}_{22} , … , {W}_{2 N} \\ … \\ {W}_{N 1} , {W}_{N 2} , … , {W}_{NN}\end{matrix} ] \\ G = [ \begin{matrix}{H}_{11} , {H}_{21} , … , {H}_{1 N} \\ {H}_{21} , {H}_{22} , … , {H}_{2 N} \\ … \\ {H}_{N 1} , {H}_{N 2} , … , {H}_{NN}\end{matrix} ] \qquad Equation 19$$

where in Equation 19, Wij is a cofactor of the component (i,j) of a matrix W. Hij being a cofactor of the component (i,j) of a matrix H.

Processing through the configuration in FIG. 8 results in the driving signals SD as in Equation 20.

$$\begin{matrix}Sd = GVX \\ = [ \begin{matrix}{H}_{11} , {H}_{12} , … , {H}_{1 N} \\ {H}_{21} , {H}_{22} , … , {H}_{2 N} \\ … \\ {H}_{N 1} , {H}_{N 2} , … , {H}_{NN}\end{matrix} ] [ \begin{matrix}{W}_{11} , {W}_{12} , … , {W}_{1 N} \\ {W}_{21} , {W}_{22} , … , {W}_{2 N} \\ … \\ {W}_{N 1} , {W}_{N 2} , … , {W}_{NN}\end{matrix} ] [ \begin{matrix}{X}_{1} \\ {X}_{2} \\ … \\ {X}_{N}\end{matrix} ]\end{matrix} \qquad Equation 20$$

Accordingly, the signals E arriving at the listener's ears are expressed by Equation 21.

$$\begin{matrix}E = WHSd \\ = WHGVX \\ = [ \begin{matrix}{W}_{11} , {W}_{21} , … , {W}_{N 1} \\ {W}_{12} , {W}_{22} , … , {W}_{N 2} \\ … \\ {W}_{1 N} , {W}_{2 N} , … , {W}_{NN}\end{matrix} ] [ \begin{matrix}{H}_{11} , {H}_{21} , … , {H}_{N 1} \\ {H}_{12} , {H}_{22} , … , {H}_{N 2} \\ … \\ {H}_{1 N} , {H}_{2 N} , … , {H}_{NN}\end{matrix} ] [ \begin{matrix}{H}_{11} , {H}_{12} , … , {H}_{1 N} \\ {H}_{21} , {H}_{22} , … , {H}_{2 N} \\ … \\ {H}_{N 1} , {H}_{N 2} , … , {H}_{NN}\end{matrix} ] [ \begin{matrix}{W}_{11} , {W}_{12} , … , {W}_{1 N} \\ {W}_{21} , {W}_{22} , … , {W}_{2 N} \\ … \\ {W}_{N 1} , {W}_{N 2} , … , {W}_{NN}\end{matrix} ] [ \begin{matrix}{X}_{1} \\ {X}_{2} \\ … \\ {X}_{N}\end{matrix} ] \\ = [ \begin{matrix}{W}_{11} , {W}_{21} , … , {W}_{N 1} \\ {W}_{12} , {W}_{22} , … , {W}_{N 2} \\ … \\ {W}_{1 N} , {W}_{2 N} , … , {W}_{NN}\end{matrix} ] [ \begin{matrix}det H , 0 , … , 0 \\ 0 , det H , 0 , … , 0 \\ … \\ 0 , … , 0 , det H\end{matrix} ] [ \begin{matrix}{W}_{11} , {W}_{12} , … , {W}_{1 N} \\ {W}_{21} , {W}_{22} , … , {W}_{2 N} \\ … \\ {W}_{N 1} , {W}_{N 2} , … , {W}_{NN}\end{matrix} ] [ \begin{matrix}{X}_{1} \\ {X}_{2} \\ … \\ {X}_{N}\end{matrix} ] \\ = det H [ \begin{matrix}{W}_{11} , {W}_{21} , … , {W}_{N 1} \\ {W}_{12} , {W}_{22} , … , {W}_{N 2} \\ … \\ {W}_{1 N} , {W}_{2 N} , … , {W}_{NN}\end{matrix} ] [ \begin{matrix}{W}_{11} , {W}_{12} , … , {W}_{1 N} \\ {W}_{21} , {W}_{22} , … , {W}_{2 N} \\ … \\ {W}_{N 1} , {W}_{N 2} , … , {W}_{NN}\end{matrix} ] [ \begin{matrix}{X}_{1} \\ {X}_{2} \\ … \\ {X}_{N}\end{matrix} ] \\ = det H [ \begin{matrix}det W , 0 , … , 0 \\ 0 , det W , 0 , … , 0 \\ … \\ 0 , … , 0 , det W\end{matrix} ] [ \begin{matrix}{X}_{1} \\ {X}_{2} \\ … \\ {X}_{N}\end{matrix} ] \\ = ( det H ) ( det W ) X\end{matrix} \qquad Equation 21$$

where (detH)X=Y, Y is a signal through the processing step that reduces a spatial crosstalk to be generated in regard to the input signal in a space ranging from loudspeakers to the listener's ears.

As seen from Equation 21, it can be understood that detH and detW are coefficients having a frequency characteristic, the signals E that are signals reproduced by processing as shown in FIG. 8, arriving at the listener's ears, to which the characteristics of detH and detW are added, however, the in-casing crosstalk and spatial components are eliminated. Here, in the case of achieving three-dimensional acoustic image localization, even when a plurality of loudspeakers is present, it is known that the phase and amplitude differences between a plurality of signals are important. According to Equation 21, since the plurality of signals described above undergoes a similar extent of transformation, the relationships of each signal's phase and amplitude differences are maintained, and satisfactory stereophonic effects can be obtained. Namely, when input signals X are expected to present stereophonic effects at a plurality of the left/right ears, the combination of a means for canceling spatial crosstalk and a means for canceling in-casing crosstalk can produce three-dimensional sound image localization that has not been conventionally produced in mobile terminals. When the signals E being conveyed to the listener's ears are desired to agree with the input signals X, a filter, with the transfer function of 1/(detH*detW), corresponding to the number of signals, i.e., only N in this case, may be implemented posterior to the processing of FIG. 8.

It should be noted that when in-casing transfer functions Hii and Hij, are common with each other, or when those are considered to be so approximate that they are assumed to be common with each other, it can be assumed that Hᵢᵢ=H_{D} and Hᵢⱼ=H_{X}. As a result, when loudspeakers are symmetrically arranged in the mobile terminal, manufacturing costs can be reduced by providing commonality to the transfer functions.

Furthermore, when spatial transfer functions Wᵢᵢ and Wᵢⱼ, are common with each other, or when those are considered to be so approximate that they are assumed to be common with each other, it can be assumed that Wᵢᵢ=W_{D} and Wᵢⱼ=W_{X}. As a result, when mobile terminals are manufactured assuming that a listener is positioned centrally in front of a pair of loudspeakers, manufacturing costs can be reduced by providing commonality to the transfer functions.

Furthermore, in some cases, the transfer function Hᵢⱼ may include loudspeaker characteristics, in addition to acoustic couplings inside the casing. The operation of a three-loudspeaker reproduction system will be specifically described as below. First, for three loudspeakers, signals S being emitted from the reproduction system, driving signals SD, the in-casing transfer function H, the spatial transfer function W are given as Equation 22.

$$S = {[ {S}_{1} , {S}_{2} , {S}_{3} ]}^{T} \\ Sd = {[ {Sd}_{1} , {Sd}_{2} , {Sd}_{3} ]}^{T} \\ H = [ \begin{matrix}{H}_{11} , {H}_{21} , {H}_{31} \\ {H}_{12} , {H}_{22} , {H}_{32} \\ {H}_{13} , {H}_{23} , {H}_{33}\end{matrix} ] \\ W = [ \begin{matrix}{W}_{11} , {W}_{21} , {W}_{31} \\ {W}_{12} , {W}_{22} , {W}_{32} \\ {W}_{13} , {W}_{23} , {W}_{33}\end{matrix} ] \qquad Equation 22$$

where the in-casing crosstalk canceling filter G and the spatial crosstalk canceling filter V are expressed as, e.g., Equation 22.

$$\begin{matrix}V = [ \begin{matrix}{W}_{11} , {W}_{12} , {W}_{13} \\ {W}_{21} , {W}_{22} , {W}_{23} \\ {W}_{31} , {W}_{32} , {W}_{33}\end{matrix} ] \\ = [ \begin{matrix}{W}_{22} {W}_{33} - {W}_{23} {W}_{32} , {W}_{21} {W}_{33} - {W}_{23} {W}_{31} , {W}_{21} {W}_{32} - {W}_{22} {W}_{31} \\ {W}_{12} {W}_{33} - {W}_{13} {W}_{32} , {W}_{11} {W}_{33} - {W}_{13} {W}_{31} , {W}_{11} {W}_{32} - {W}_{12} {W}_{31} \\ {W}_{12} {W}_{23} - {W}_{13} {W}_{22} , {W}_{11} {W}_{23} - {W}_{13} {W}_{21} , {W}_{11} {W}_{32} - {W}_{12} {W}_{21}\end{matrix} ]\end{matrix} \\ \begin{matrix}G = [ \begin{matrix}{H}_{11} , {H}_{12} , {H}_{13} \\ {H}_{21} , {H}_{22} , {H}_{23} \\ {H}_{31} , {H}_{32} , {H}_{33}\end{matrix} ] \\ = [ \begin{matrix}{H}_{22} {H}_{33} - {H}_{23} {H}_{32} , {H}_{21} {H}_{33} - {H}_{23} {H}_{31} , {H}_{21} {H}_{32} - {H}_{22} {H}_{31} \\ {H}_{12} {H}_{33} - {H}_{13} {H}_{32} , {H}_{11} {H}_{33} - {H}_{13} {H}_{31} , {H}_{11} {H}_{32} - {H}_{12} {H}_{31} \\ {H}_{12} {H}_{23} - {H}_{13} {H}_{22} , {H}_{11} {H}_{23} - {H}_{13} {H}_{21} , {H}_{11} {H}_{32} - {H}_{12} {H}_{21}\end{matrix} ]\end{matrix} \qquad Equation 23$$

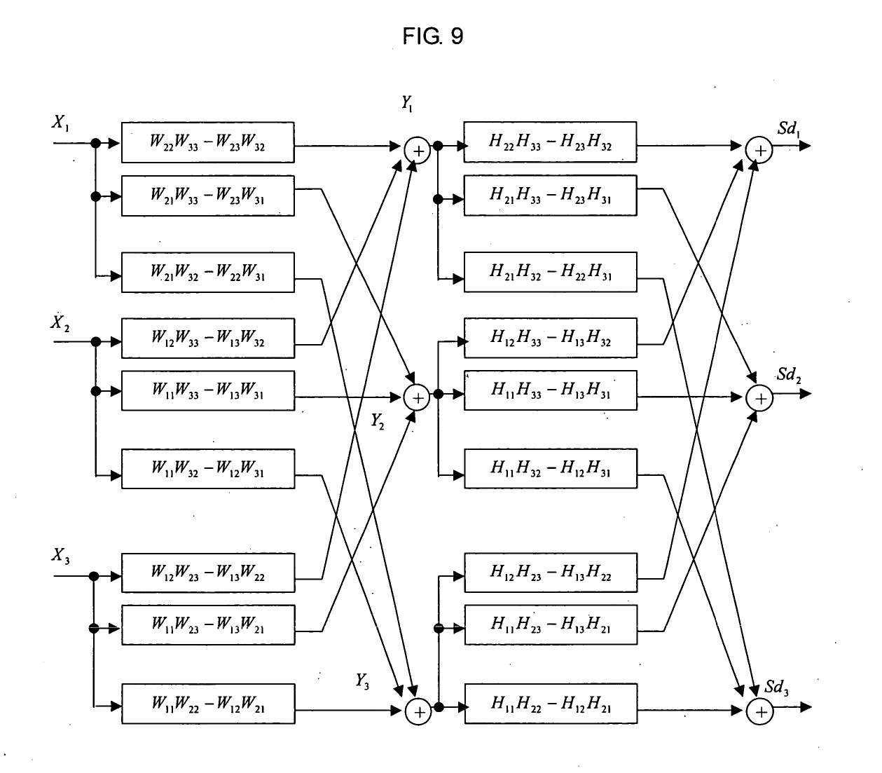

When, based on the configuration of FIG. 9, the processing is implemented by the filtering characteristics of Equation 23, the driving signals SD are expressed as Equation 24.

$$\begin{matrix}Sd = GVX \\ = [ \begin{matrix}{H}_{11} , {H}_{12} , {H}_{13} \\ {H}_{21} , {H}_{22} , {H}_{23} \\ {H}_{31} , {H}_{32} , {H}_{33}\end{matrix} ] [ \begin{matrix}{W}_{11} , {W}_{12} , {W}_{13} \\ {W}_{21} , {W}_{22} , {W}_{23} \\ {W}_{31} , {W}_{32} , {W}_{33}\end{matrix} ] [ \begin{matrix}{X}_{1} \\ {X}_{2} \\ {X}_{3}\end{matrix} ]\end{matrix} \qquad Equation 24$$

E

[symbol]

[symbol]

[symbol]

[symbol]

Thus, signals E arriving at the listener's ears are expressed by Equation 25.

$$\begin{matrix}E = WHSd \\ = WHGVX \\ = [ \begin{matrix}{W}_{11} , {W}_{21} , {W}_{31} \\ {W}_{12} , {W}_{22} , {W}_{32} \\ {W}_{13} , {W}_{23} , {W}_{33}\end{matrix} ] [ \begin{matrix}{H}_{11} , {H}_{21} , {H}_{31} \\ {H}_{12} , {H}_{22} , {H}_{32} \\ {H}_{13} , {H}_{23} , {H}_{33}\end{matrix} ] [ \begin{matrix}{H}_{11} , {H}_{12} , {H}_{3 N} \\ {H}_{21} , {H}_{22} , {H}_{23} \\ {H}_{31} , {H}_{32} , {H}_{33}\end{matrix} ] [ \begin{matrix}{W}_{11} , {W}_{12} , {W}_{13} \\ {W}_{21} , {W}_{22} , {W}_{23} \\ {W}_{31} , {W}_{32} , {W}_{33}\end{matrix} ] [ \begin{matrix}{X}_{1} \\ {X}_{2} \\ {X}_{3}\end{matrix} ] \\ = [ \begin{matrix}{W}_{11} , {W}_{21} , {W}_{31} \\ {W}_{12} , {W}_{22} , {W}_{32} \\ {W}_{13} , {W}_{23} , {W}_{33}\end{matrix} ] [ \begin{matrix}det H , 0 , 0 \\ 0 , det H , 0 \\ 0 , 0 , det H\end{matrix} ] [ \begin{matrix}{W}_{11} , {W}_{12} , {W}_{13} \\ {W}_{21} , {W}_{22} , {W}_{23} \\ {W}_{31} , {W}_{32} , {W}_{33}\end{matrix} ] [ \begin{matrix}{X}_{1} \\ {X}_{2} \\ {X}_{3}\end{matrix} ] \\ = det H [ \begin{matrix}{W}_{11} , {W}_{21} , {W}_{31} \\ {W}_{12} , {W}_{22} , {W}_{32} \\ {W}_{13} , {W}_{23} , {W}_{33}\end{matrix} ] [ \begin{matrix}{W}_{11} , {W}_{12} , {W}_{13} \\ {W}_{21} , {W}_{22} , {W}_{23} \\ {W}_{31} , {W}_{32} , {W}_{33}\end{matrix} ] [ \begin{matrix}{X}_{1} \\ {X}_{2} \\ {X}_{3}\end{matrix} ] \\ = det H [ \begin{matrix}det W , 0 , 0 \\ 0 , det W , 0 \\ 0 , 0 , det W\end{matrix} ] [ \begin{matrix}{X}_{1} \\ {X}_{2} \\ {X}_{3}\end{matrix} ] \\ = ( det H ) ( det W ) X\end{matrix} \qquad Equation 25$$

where (detH)X=Y, Y is a signal through the processing step that reduces a spatial crosstalk to be generated in regard to the input signal in a space ranging from loudspeakers to the listener's ears.
detH=H₁₁H₂₂H₃₃−H₁₁H₂₃H₃₂+H₁₂H₂₃H₃₁−H₁₂H₂₁H₃₃+H₁₃H₂₁H₃₂−H₁₃H₂₂H₃₁
detW=W₁₁W₂₂W₃₃−W₁₁W₂₃W₃₂+W₁₂W₂₃W₃₁−W₁₂W₂₁W₃₃+W₁₃W₂₁W₃₂−W₁₃W₂₂W₃₁

It can be understood that detH and detW are coefficients having frequency characteristics, and signals E that are signals reproduced by processing as shown in FIG. 9, arriving at the listener's ears, to which the characteristics of detH and detW are added, however, the in-casing and crosstalk spatial components are removed. When the signals E arriving at the listener's ears are desired to be thoroughly made coincident with the input signals X, a filter with characteristics of 1/(detH*detW), corresponding to the number of signals, i.e., only three in this case, may be implemented anterior/posterior to the processing as shown in FIG. 9.

1. A method of acoustic signal reproduction in a mobile terminal including a plurality of loudspeakers accommodated inside a casing of the mobile terminal, the method of acoustic signal reproduction comprising:
Processing Step 1 of reducing spatial crosstalk generated, with respect to signals, inputted into the loudspeakers, in a space ranging from the loudspeakers to a control point; and
Processing Step 2 of reducing inter-loudspeaker crosstalk generated inside the casing, with respect to signals having gone through Processing Step 1.

2. A method of acoustic signal reproduction as recited in claim 1, wherein Processing Step 2 includes a summing step to Step-1-processed signals going into a one of the loudspeakers a reduction signal for reducing sounds inside the casing leaking out from another of the loudspeakers into the one of the loudspeakers.

3. A method of acoustic signal reproduction as recited in claim 2, wherein the reduction signal is generated by processing signals having gone through Processing Step 1, into the other of the loudspeakers.

4. A method of acoustic signal reproduction as recited in claim 3, wherein the processing of the Step-1-processed signals going into the other of the loudspeakers is performed according to a characteristic obtained by:
dividing a transfer function for a driving signal, for driving the other of the loudspeakers, as altered by at least acoustic couplings until emitted from the one of the loudspeakers,
by a transfer function for a driving signal, for driving the one of the loudspeakers, as altered by at least amplifier/loudspeaker characteristics until emitted from the one of the loudspeakers; and reversing the arithmetic sign.

5. A method of acoustic signal reproduction as recited in claim 1, wherein Processing Step 2 includes:
a first in-casing direct processing step of processing Step-1-processed signals going into the one of the loudspeakers to obtain a direct component for the one of the loudspeakers;
a first in-casing crossover processing step of processing Step-1-processed signals going into the other of the loudspeakers to obtain a crossover component for the one of the loudspeakers;
a first summing step of summing together both post-processed signals to produce a driving signal for driving the one of the loudspeakers;
a second in-casing direct processing step of processing Step-1-processed signals going into the other of the loudspeakers to obtain a direct component for the other of the loudspeakers;
a second in-casing crossover processing step of processing Step-1-processed signals going into the one of the loudspeakers to obtain a crossover component for the other of the loudspeakers; and
a second summing step of summing together both post-processed signals to produce a driving signal for driving the second loudspeakers.

6. A method of acoustic signal reproduction as recited in claim 5, wherein
the first in-casing direct processing step is a process according to a transfer function for the driving signal, for driving the other of the loudspeakers as altered by amplifier/loudspeaker characteristics until emitted from the other of the loudspeakers,
the first in-casing crossover processing step is a process according to a transfer function for the driving signal, for driving the other of the loudspeakers as altered by at least acoustic couplings characteristics until emitted from the one of loudspeakers,
the second in-casing direct processing step is a process according to a transfer function for the driving signal, for driving the one of loudspeakers as altered by amplifier/loudspeaker characteristics until emitted from the one of loudspeakers,
the second in-casing crossover processing step is a process according to a transfer function for the driving signal, for driving the one of loudspeakers, as altered by at least acoustic couplings characteristics until emitted from the other of loudspeakers.

7. A method of acoustic signal reproduction as recited in claim 5, wherein Processing Step 2 includes a post-processing step further processing one of the summed signals so that loudspeaker's emission signals emitted from the one of the loudspeakers are made approximately coincident with the amplitude/phase of Processing-Step-1-processed signals to the one of the loudspeakers.

8. A method of acoustic signal reproduction as recited in claim 5, wherein Processing Step 2 includes a pre-processing step processing, posterior to Processing Step 1 and prior to Processing Step 2, Processing-Step-1-processed signals to the one of the loudspeakers so that the-one-of-the-loudspeakers' emission signals are made approximately coincident with the amplitude/phase of Processing-Step-1-processed signals to the one of the loudspeakers.

9. A method for acoustic signal reproduction as recited in claim 3, wherein processing Processing-Step-1-processed signals to the other of the loudspeakers is performed on a subband basis of the Processing-Step-1-processed signals to the other of the loudspeakers.

10. A method of acoustic signal reproduction as recited in claim 4, wherein processing Processing-Step-1-processed signals to the other of the loudspeakers is performed according to a characteristic obtained by passing signals through a low-pass filter having the transfer function.

11. A method of acoustic signal reproduction as recited in claim 3, wherein correlation between the Processing-Step-1-processed signals to the other of the loudspeakers and the Processing-Step-1-processed signals to the one loudspeaker is obtained on a frequency component basis, so that processing Processing-Step-1-processed signals to the other of the loudspeakers is performed according to the correlation.

12. A method of acoustic signal reproduction as recited in claims 3, wherein processing Processing-Step-1-processed signals to the other of the loudspeakers is performed according to a characteristic obtained by multiplying the Processing-Step-1-processed signals to the other of the loudspeakers, by a scalar value less than one, and reversing the arithmetic sign.

13. A method of acoustic signal reproduction as recited in claim 5, wherein one in-casing direct processing step and another in-casing direct processing step are approximately in common with one in-casing crossover processing step and another in-casing crossover processing step, respectively.

14. A mobile terminal including a plurality of loudspeakers accommodated inside a casing of the mobile terminal, the mobile terminal, comprising a processing means 1 for reducing spatial crosstalk generated with respect to input signals to the loudspeakers, in a space ranging from the loudspeakers to a control point, and a processing means 2 for reducing inter-loudspeaker crosstalk being generated inside the casing, with respect to processing-means-1-processed signals.

15. A mobile terminal as recited in claim 14, wherein the processing means 2 sums together a reduction signal for reducing sounds leaking out, inside the casing, from another of the loudspeakers into a one of the loudspeakers, and processing-means-1-processed signals to the one of the loudspeakers.

16. A mobile terminal as recited in claim 15, wherein the reduction signal is generated by processing processing-means-1-processed signals to the other of the loudspeakers.

17. A mobile terminal as recited in claim 16, wherein processing processing-means-1-processed signals to the other of the loudspeakers is performed according to a characteristic obtained by: dividing
a transfer function for the driving signal, for driving the other of the loudspeakers, as altered by acoustic couplings until emitted from the one of the loudspeakers, by
a transfer function for the driving signal, for driving the one of the loudspeakers, as altered by at least amplifier/loudspeaker characteristics until emitted from the one of the loudspeakers; and
reversing the arithmetic sign.

18. A mobile terminal as recited in claim 14, wherein the processing means 2 includes:
a first in-casing direct processing means for processing processing-means-1-processed signals going into the one of the loudspeakers;
a first in-casing crossover processing means for processing processing-means-1-processed signals going into the other of the loudspeakers to obtain a crossover component for the one of the loudspeakers;
a first summing means for summing together both post-processed signals to produce a driving signal for driving the one of the loudspeakers;
a second in-casing direct processing means for processing processing-means-1-processed signals going into the other of the loudspeakers;
a second in-casing crossover processing means for processing processing-means-1-processed signals going into the one of the loudspeakers to obtain crossover components for the other of the loudspeakers; and
a second summing means for summing together both post-processed signals to produce a driving signal for driving a second loudspeaker.

19. A mobile terminal as recited in claim 18, wherein:
the first in-casing direct processing means performs processing according to a transfer function for a driving signal, for driving the other of the loudspeakers, as altered by at least either amplifier or loudspeaker characteristics until emitted from the other of the loudspeakers;
the first in-casing crossover processing means performs processing according to a transfer function for the driving signal, for driving the other of the loudspeakers, as altered by at least acoustic couplings characteristics until emitted from the one of the loudspeakers;
the second in-casing direct processing means performs processing according to a transfer function for a driving signal, for driving the one of the loudspeakers, as altered by amplifier or loudspeaker characteristics until emitted from the one of the loudspeakers; and
the second in-casing crossover processing means performs processing according to a transfer function for the driving signal, for driving the one of the loudspeakers, as altered by at least acoustic couplings characteristics until emitted from the other of the loudspeakers

20. A mobile terminal as recited in claim 18, further comprising a post-processing means for processing one summed signal so that loudspeaker's emission signals emitted from the one of the loudspeakers are made approximately coincident with the amplitude/phase of the processing-means-1-processed signals to the one of the loudspeakers.

21. A mobile terminal as recited in claim 18, further comprising a pre-processing means for processing, posterior to Processing Step 1 and prior to Processing Step 2, processing-means-1-processed signals to the one of the loudspeakers so that the-one-of-loudspeakers' emission signals are made approximately coincident with the amplitude/phase of the processing-means-1-processed signals to the one of the loudspeakers.

22. A mobile terminal as recited in claim 16, wherein processing processing-means-1-processed signals to the other of the loudspeakers is performed on a subband basis of the processing-means-1-processed signals to the other of the loudspeakers.

23. A mobile terminal as recited in claim 17, wherein processing processing-means-1-processed signals to the other of the loudspeakers is performed according to a characteristic obtained by passing signals through a low-pass filter.

24. A mobile terminal as recited in claim 16, wherein correlation between processing-means-1-processed signals to the other of the loudspeakers and processing-means-1-processed signals to the one of the loudspeakers is obtained on a frequency component basis, so that processing processing-means-1-processed signals to the other of the loudspeakers is performed according to the correlation.

25. A mobile terminal as recited in claim 16, wherein processing processing-means-1-processed signals to the other of the loudspeakers is performed according to a characteristic obtained by multiplying processing-means-1-processed signals to the other of the loudspeakers, by a scalar value less than one, and reversing the arithmetic sign.

26. A method for acoustic signal reproduction as recited in claim 18, wherein one in-casing direct processing means and another in-casing direct processing means, are in common with one in-casing crossover processing means, and another in-casing crossover processing means, respectively.

27. A method of acoustic signal reproduction in a mobile terminal including a quantity N of loudspeakers accommodated inside a casing of the mobile terminal, the acoustic-signal reproduction method characterized in that given that a loudspeaker's emission signal Sᵢ emitted from an i-th loudspeaker is expressed by the following equation, using a matrix H having a transfer function Hᵢⱼ for a driving signal S_{di}, for driving the i-th loudspeaker, as altered by at least in-casing acoustic couplings until emitted from a j-th loudspeaker, and a transfer function Hᵢᵢ for a driving signal, for driving the i-th loudspeaker, as altered by at least either amplifier or loudspeaker characteristics until emitted from the i-th loudspeaker,
$$[ \begin{matrix}{S}_{1} \\ {S}_{2} \\ ⋯ \\ {S}_{N}\end{matrix} ] = HSd = [ \begin{matrix}{H}_{11} , {H}_{21} , ⋯ , {H}_{N 1} \\ {H}_{12} , {H}_{22} , ⋯ , {H}_{N 2} \\ ⋯ \\ {H}_{1 N} , {H}_{2 N} , ⋯ , {H}_{N N}\end{matrix} ] [ \begin{matrix}{Sd}_{1} \\ {Sd}_{2} \\ ⋯ \\ {Sd}_{N}\end{matrix} ] \qquad Equation 1$$
then the driving signal S_{di} for the i-th loudspeaker is generated by performing, on a signal Yᵢ corresponding to the i-th loudspeaker, the signal having passed through a processing step of reducing in input signals spatial crosstalk generating in a space ranging from the loudspeakers to a control point, a process according to the following filter characteristic G based on cofactors Qᵢⱼ of components (i,j) of the matrix H.
$$[ \begin{matrix}{Sd}_{1} \\ {Sd}_{2} \\ ⋯ \\ {Sd}_{N}\end{matrix} ] = G [ \begin{matrix}{Y}_{1} \\ {Y}_{2} \\ ⋯ \\ {Y}_{N}\end{matrix} ] where G = a [ \begin{matrix}{Q}_{11} , {Q}_{12} , ⋯ , {Q}_{1 N} \\ {Q}_{21} , {Q}_{22} , ⋯ , {Q}_{2 N} \\ ⋯ \\ {Q}_{N 1} , {Q}_{N 2} , ⋯ , {Q}_{N N}\end{matrix} ] \qquad Equation 2$$

28. A mobile terminal including a quantity N of loudspeakers accommodated inside a casing of the mobile terminal, the mobile terminal configured so that given that a loudspeaker's emission signal Sᵢ emitted from an i-th loudspeaker is expressed by the following equation, using a matrix H having a transfer function Hᵢⱼ for a driving signal S_{di}, for driving the i-th loudspeaker, as altered by at least in-casing acoustic couplings until emitted from a j-th loudspeaker, and a transfer function Hᵢᵢ for a driving signal, for driving the i-th loudspeaker, as altered by at least either amplifier or loudspeaker characteristics until emitted from the i-th loudspeaker,
$$[ \begin{matrix}{S}_{1} \\ {S}_{2} \\ ⋯ \\ {S}_{N}\end{matrix} ] = HSd = [ \begin{matrix}{H}_{11} , {H}_{21} , ⋯ , {H}_{N 1} \\ {H}_{12} , {H}_{22} , ⋯ , {H}_{N 2} \\ ⋯ \\ {H}_{1 N} , {H}_{2 N} , ⋯ , {H}_{N N}\end{matrix} ] [ \begin{matrix}{Sd}_{1} \\ {Sd}_{2} \\ ⋯ \\ {Sd}_{N}\end{matrix} ] \qquad Equation 3$$
then the driving signal S_{di} for the i-th loudspeaker is generated by performing, on a signal Yᵢ corresponding to the i-th loudspeaker, the signal having gone through a processing means for reducing in input signals spatial crosstalk generating in a space ranging from the loudspeakers to a control point, a process according to the following filter characteristic G based on cofactors Qᵢⱼ of components (i,j) of the matrix H.
$$[ \begin{matrix}{Sd}_{1} \\ {Sd}_{2} \\ ⋯ \\ {Sd}_{N}\end{matrix} ] = G [ \begin{matrix}{Y}_{1} \\ {Y}_{2} \\ ⋯ \\ {Y}_{N}\end{matrix} ] where G = a [ \begin{matrix}{Q}_{11} , {Q}_{12} , ⋯ , {Q}_{1 N} \\ {Q}_{21} , {Q}_{22} , ⋯ , {Q}_{2 N} \\ ⋯ \\ {Q}_{N 1} , {Q}_{N 2} , ⋯ , {Q}_{N N}\end{matrix} ] . \qquad Equation 4$$
